(19) United States
(12) Patent Application Publication
(10) Pub. No.: US 2026/0227954 A1
(43) Pub. Date: Aug. 6, 2026

(54) ELECTRONIC APPARATUS AND CONTROL METHOD THEREFOR

(71) Applicant: SAMSUNG ELECTRONICS CO., LTD., Suwon-si (KR)

(72) Inventors: Woosung CHUNG, Suwon-si (KR); Jongbae Kim, Suwon-si (KR); Dongyoon Kim, Suwon-si (KR); Hoseok Wey, Suwon-si (KR); Kisung Lee, Suwon-si (KR); Yongseok Jang, Suwon-si (KR)

(73) Assignee: SAMSUNG ELECTRONICS CO., LTD., Suwon-si (KR)

(21) Appl. No.: 19/645,979

(22) Filed: Apr. 13, 2026

Related U.S. Application Data
(63) Continuation of application No. PCT/KR2024/017201, filed on Nov. 4, 2024.

(30) Foreign Application Priority Data
Nov. 21, 2023 (KR) 10-2023-0162747

(51) Int. Cl. G06F 3/16

(52) U.S. Cl. CPC G06F 3/165; G06F 3/162; G06F 3/167

(57) ABSTRACT

A method of an electronic apparatus storing history information and communicating with an output device, a first device including a first microphone, and a second device including a second microphone, includes: obtaining first setting information based on the history information; transmitting, to the output device, the first setting information and information on a first target signal for testing; receiving, from the first device, information on a first measurement obtained by recording the information on the first target signal output from the output device; receiving, from the second device, information on a second measurement obtained by recording the information on the first target signal output from the output device; obtaining second setting information based on the information on the first measurement and the information on the second measurement; and transmitting, to the output device, the second setting information and information on a second target audio signal for a user.

### CROSS-REFERENCE TO RELATED APPLICATIONS

This application is a by-pass continuation application of International Application No. PCT/KR2024/017201, filed on November 4, 2024, which is based on and claims priority to Korean Patent Application No. 10-2023-0162747, filed on November 21, 2023, in the Ministry of Intellectual Property, the disclosures of which are incorporated by reference herein their entireties.

### BACKGROUND

### 1. Field

The present disclosure relates to an electronic apparatus and a control method therefor, and more particularly, to an electronic apparatus for controlling settings of an external speaker connectable to the electronic apparatus, and a control method therefor.

### 2. Description of Related Art

A speaker may be connected to an electronic apparatus used by a user. The electronic apparatus may output audio content through the connected speaker. In order for the electronic apparatus and the speaker to perform mutual communication, mutual registration may be required according to a predetermined communication scheme.

When the user listens to audio content, the user may use a speaker (e.g., an external speaker). The user may maintain initial settings or use an automatic tuning function to manage settings of the speaker. However, use of the automatic tuning function requires direct input of information on the user, which may cause inconvenience.

When the automatic tuning function is used, there is no method for checking whether tuning is normally performed, and thus a quality issue related to the speaker settings may occur.

### SUMMARY

The present disclosure provides an electronic apparatus for obtaining audio setting information of an audio output device connected to the electronic apparatus based on history information and a measurement audio signal, and a control method therefor.

According to an aspect of the present disclosure, an electronic apparatus includes: a memory storing history information related to audio settings; a communication interface configured to communicate with an audio output device, a first external device including a first microphone, and a second external device including a second microphone; and at least one processor configured to: obtain first audio setting information based on the history information; transmit, to the audio output device, the first audio setting information and information related to a first target audio signal for testing; receive, from the first external device through the communication interface, information related to a first measurement audio signal obtained by recording the information related to the first target audio signal output from the audio output device; receive, from the second external device through the communication interface, information related to a second measurement audio signal obtained by recording the information related to the first target audio signal output from the audio output device; obtain second audio setting information based on the information related to the first measurement audio signal and the information related to the second measurement audio signal; and transmit, to the audio output device through the communication interface, the second audio setting information and information related to a second target audio signal for a user.

According to an aspect of the present disclosure, a method performed by an electronic apparatus that stores history information related to audio settings and that is configured to communicate with an audio output device, a first external device including a first microphone, and a second external device including a second microphone, includes: obtaining first audio setting information based on the history information; transmitting, to the audio output device, the first audio setting information and information related to a first target audio signal for testing; receiving, from the first external device, information related to a first measurement audio signal obtained by recording the information related to the first target audio signal output from the audio output device; receiving, from the second external device, information related to a second measurement audio signal obtained by recording the information related to the first target audio signal output from the audio output device; obtaining second audio setting information based on the information related to the first measurement audio signal and the information related to the second measurement audio signal; and transmitting, to the audio output device, the second audio setting information and information related to a second target audio signal for a user.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an operation in which an audio signal output through a single audio output device is received by an external device according to an embodiment;

FIG. 2 illustrates an operation in which an audio signal output through a single audio output device is received by an external device and a terminal device according to an embodiment;

FIG. 3 illustrates an operation in which audio signals output through a plurality of audio output devices are received by an external device according to an embodiment;

FIG. 4 illustrates an operation in which audio signals output through a plurality of audio output devices are received by an external device according to an embodiment;

FIG. 5 illustrates an electronic apparatus according to an embodiment;

FIG. 6 illustrates a detailed configuration of the electronic apparatus illustrated in FIG. 5 according to an embodiment;

FIG. 7 illustrates an operation for providing audio setting information according to an embodiment;

FIG. 8 illustrates an operation for obtaining audio setting information according to an embodiment;

FIG. 9 illustrates the operation of obtaining audio setting information according to an embodiment;

FIG. 10 illustrates an operation for obtaining first audio setting information according to an embodiment;

FIG. 11 illustrates an operation for obtaining first audio setting information according to an embodiment;

FIG. 12 illustrates an operation for obtaining first audio setting information according to an embodiment;

FIG. 13 illustrates an operation for providing audio setting information by using a plurality of external devices according to an embodiment;

FIG. 14 illustrates an operation for providing audio setting information by using a plurality of audio output devices according to an embodiment;

FIG. 15 illustrates an operation for providing audio setting information by using an external device and an audio output device according to an embodiment;

FIG. 16 illustrates an operation for providing audio setting information by using a terminal device according to an embodiment;

FIG. 17 illustrates an operation for obtaining first audio setting information according to an embodiment;

FIG. 18 illustrates a screen related to audio setting information according to an embodiment;

FIG. 19 illustrates a screen for obtaining context information according to an embodiment;

FIG. 20 illustrates a screen for performing audio setting according to an embodiment;

FIG. 21 illustrates a screen indicating a location of an audio output device according to an embodiment;

FIG. 22 illustrates an operation for obtaining second audio setting information according to an embodiment;

FIG. 23 illustrates an operation for obtaining audio setting information according to an embodiment;

FIG. 24 illustrates a user database according to an embodiment;

FIG. 25 illustrates an operation for obtaining first audio setting information by using a pre-registered terminal device according to an embodiment; and

FIG. 26 illustrates a control method for an electronic apparatus according to an embodiment.

### DETAILED DESCRIPTION

Hereinafter, the present disclosure is described with reference to the accompanying drawings.

General terms currently widely used are selected as terms used in the embodiments of the present disclosure in consideration of their functions in the present disclosure, and may be changed based on the intentions of those skilled in the art or a judicial precedent, the emergence of a new technique, or the like. In addition, in a specific case, terms arbitrarily selected by an applicant may be present. Here, the meanings of such terms are mentioned in corresponding descriptions of the present disclosure. Therefore, the terms used in the present disclosure need to be defined on the basis of the meanings of the terms and the contents throughout the present disclosure rather than simple names of the terms.

In the present disclosure, the expression such as “have,” “may have,” “include,” or “may include,” indicates the presence of a corresponding feature (for example, a numerical value, a function, an operation, or a component such as a part), and does not exclude the presence of an additional feature.

An expression such as “at least one of A or/and B” may indicate either “A or B,” or “both of A and B.”

Expressions such as “first” and “second,” used in the present disclosure may indicate various components regardless of the sequence or importance of the components. The expression is used only to distinguish one component from another component, and does not limit the corresponding component.

When any component (e.g., a first component) is mentioned to be “(operatively or communicatively) coupled with/to” or “connected to” another component (e.g., a second component), the any component is directly coupled to another component or may be coupled to another component through yet another component (e.g., a third component).

A term of a singular number may include its plural number unless explicitly indicated otherwise in the context. In the present disclosure, terms such as “include” or “have” indicate that the presence of the features, numbers, steps, operations, components, parts, or combinations thereof, which are described in the present disclosure, and do not preclude the presence or addition of one or more other features, numbers, steps, operations, components, parts, or combinations thereof.

In the present disclosure, a “module” or a “part” may perform at least one function or operation, and be implemented by hardware or software or be implemented by a combination of hardware and software. In addition, a plurality of “modules” or a plurality of “parts” may be integrated in at least one module and be implemented by at least one processor except for a “module” or a “part” that needs to be implemented by specific hardware.

In the present disclosure, a term such as a “user” may refer to a person who uses an electronic apparatus or an apparatus (e.g., an artificial intelligence electronic apparatus) which uses an electronic apparatus.

Hereinafter, embodiments of the present disclosure are described in more detail with reference to the accompanying drawings.

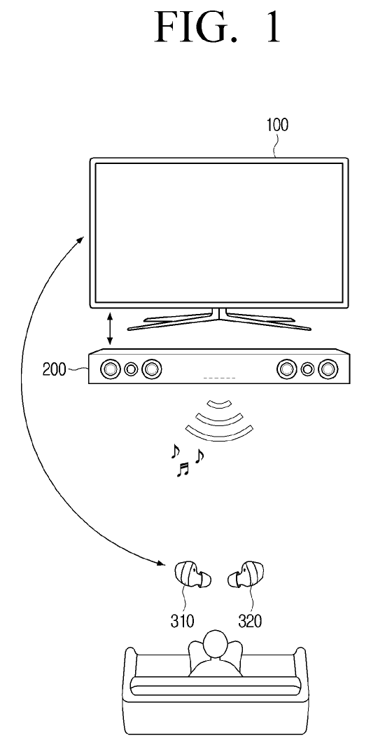

FIG. 1 illustrates an operation in which an audio signal output through a single audio output device is received by an external device according to an embodiment.

Referring to FIG. 1, an electronic apparatus 100 may transmit an audio signal to an audio output device 200. The electronic apparatus 100 may be a device for providing an audio signal. The audio output device 200 may be a device including a speaker.

The audio output device 200 may output an audio signal. A first external device 310 and a second external device 320 may obtain an audio signal output through the audio output device 200. The first external device 310 and the second external device 320 may be devices included in one set. For example, the first external device 310 and the second external device 320 may be an earset (a set of two earphones). Each of the first external device 310 and the second external device 320 may include a microphone.

The first external device 310 and the second external device 320 may obtain (or record) an audio signal output from the audio output device 200. Each audio signal recorded by the first external device 310 and the second external device 320 may be used in an operation for analyzing audio setting information.

According to various embodiments, an audio signal may be recorded only by any one of the first external device 310 or the second external device 320.

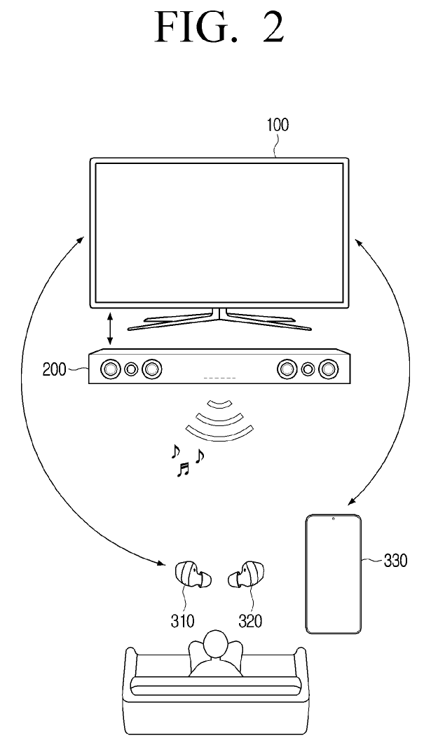

FIG. 2 illustrates an operation in which an audio signal output through a single audio output device is received by an external device and a terminal device according to an embodiment.

Descriptions of the electronic apparatus 100, the audio output device 200, the first external device 310, and the second external device 320 are provided with reference to FIG. 1. Redundant descriptions thereof are thus omitted.

A terminal device 330 may additionally obtain an audio signal output from the audio output device 200. The terminal device 330 may include a microphone. Each audio signal recorded by the first external device 310, the second external device 320, and the terminal device 330 may be used in the operation for analyzing audio setting information.

The first external device 310 may transmit, to the electronic apparatus 100, a first measurement audio signal including the recorded audio signal.

The second external device 320 may transmit, to the electronic apparatus 100, a second measurement audio signal including the recorded audio signal.

The terminal device 330 may transmit, to the electronic apparatus 100, a third measurement audio signal including the recorded audio signal.

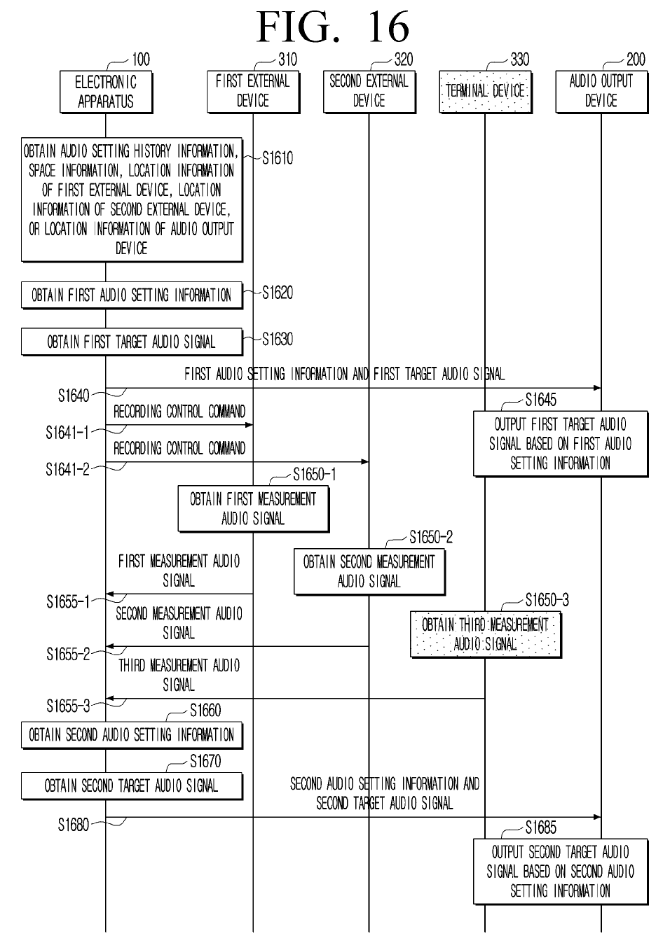

The electronic apparatus 100 may generate audio setting information appropriate for the audio output device 200 by using the first measurement audio signal, the second measurement audio signal, and the third measurement audio signal received from each of the first external device 310, the second external device 320, and the terminal device 330. Detailed operations related thereto are described with reference to FIG. 16.

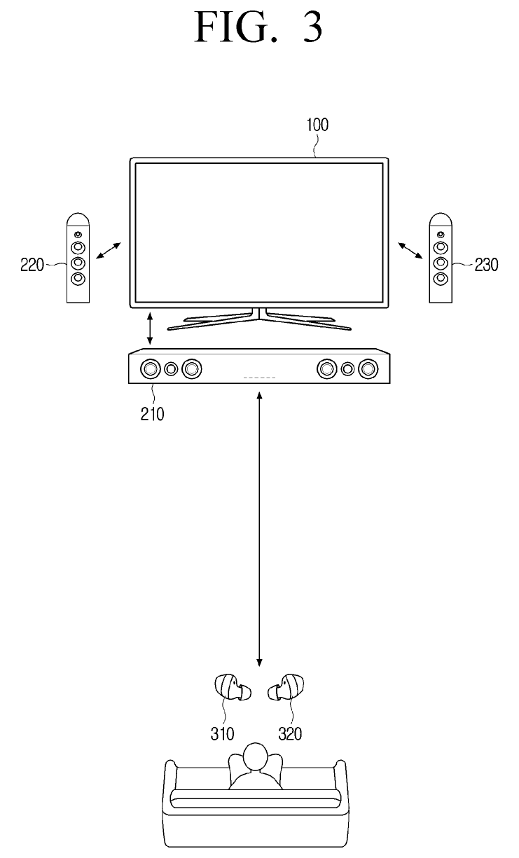

FIG. 3 illustrates an operation in which audio signals output through a plurality of audio output devices are received by an external device according to an embodiment.

Descriptions of the electronic apparatus 100, the audio output device 200, the first external device 310, and the second external device 320 are provided with reference to FIG. 1. Redundant descriptions thereof are thus omitted.

The audio output device 200 may include a plurality of devices. The audio output device 200 may include at least one of a first audio output device 210, a second audio output device 220, or a third audio output device 230.

At least one of the first audio output device 210, the second audio output device 220, or the third audio output device 230 may be connected to the electronic apparatus 100. The electronic apparatus 100 may transmit an audio signal to at least one of the first audio output device 210, the second audio output device 220, or the third audio output device 230. An audio signal may be output through at least one of the first audio output device 210, the second audio output device 220, or the third audio output device 230. The output audio signal may be obtained through the first external device 310 and the second external device 320.

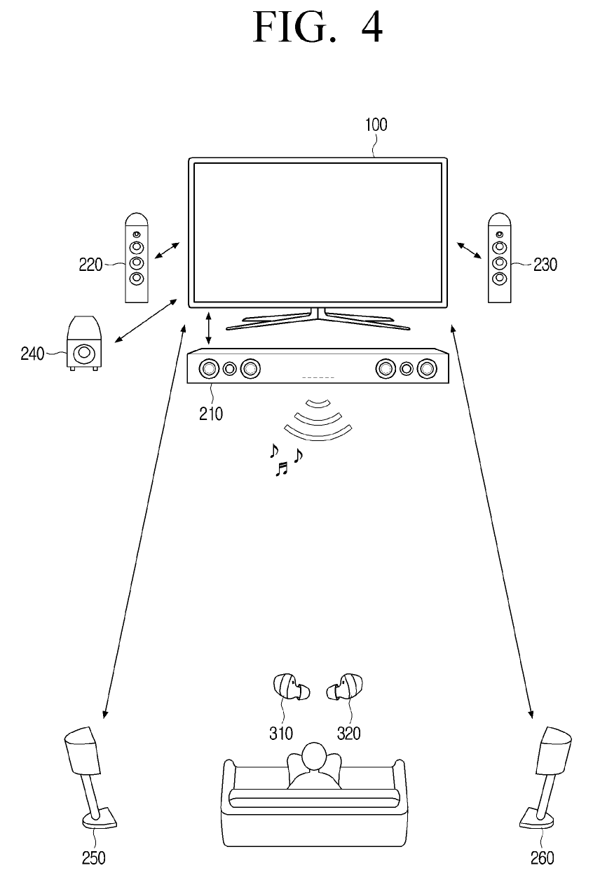

FIG. 4 illustrates an operation in which audio signals output through a plurality of audio output devices are received by an external device according to an embodiment.

Descriptions of the electronic apparatus 100, the audio output device 200, the first external device 310, and the second external device 320 are provided with reference to FIG. 1. Redundant descriptions thereof are thus omitted.

The audio output device 200 may include a plurality of devices. The audio output device 200 may include at least one of the first audio output device 210, the second audio output device 220, the third audio output device 230, a fourth audio output device 240, a fifth audio output device 250, or a sixth audio output device 260.

At least one of the plurality of devices 210, 220, 230, 240, 250, or 260 may be connected to the electronic apparatus 100. The electronic apparatus 100 may transmit an audio signal to at least one of the plurality of devices 210, 220, 230, 240, 250, or 260. An audio signal may be output through at least one of the plurality of devices 210, 220, 230, 240, 250, or 260. The output audio signal may be obtained through the first external device 310 and the second external device 320.

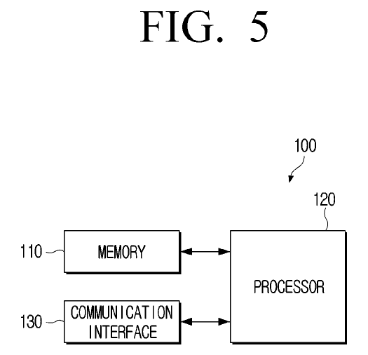

FIG. 5 illustrates an electronic apparatus 100 according to an embodiment.

Referring to FIG. 5, the electronic apparatus 100 may include at least one of a memory 110, at least one processor 120, or a communication interface 130.

The electronic apparatus 100 may include various devices. The electronic apparatus 100 may be implemented as an electronic board, a television (TV), a desktop personal computer (PC), a laptop computer, a smartphone, a tablet PC, a server, or the like. The above-described examples are merely examples for explaining the electronic apparatus, and the electronic apparatus is not necessarily limited to the above-described devices.

The memory 110 may store history information related to audio settings.

The history information may indicate information related to settings applied to an audio output function. The history information may include a past history of settings applied to the audio output function.

The history information may include at least one of a preferred volume, a preferred frequency band, a preferred style, preferred equalizer (EQ) setting information, or hearing ability information.

The hearing ability information may include at least one of a user age, a user gender, or an audible frequency range.

The audible frequency range may be identified based on at least one of the user age or the user gender. The user age and the audible frequency range may have an inversely proportional relationship. As the user age increases, the audible frequency range may decrease.

According to an embodiment, the history information may be stored in the electronic apparatus 100. The electronic apparatus 100 may obtain the history information stored in the memory 110.

According to an embodiment, the history information may be stored in at least one of the first external device 310 or the second external device 320. The electronic apparatus 100 may request the history information from at least one of the first external device 310 or the second external device 320. The electronic apparatus 100 may receive the history information from at least one of the first external device 310 or the second external device 320.

According to an embodiment, the history information may be stored in the terminal device 330. The electronic apparatus 100 may request the history information from the terminal device 330. The electronic apparatus 100 may receive the history information from the terminal device 330.

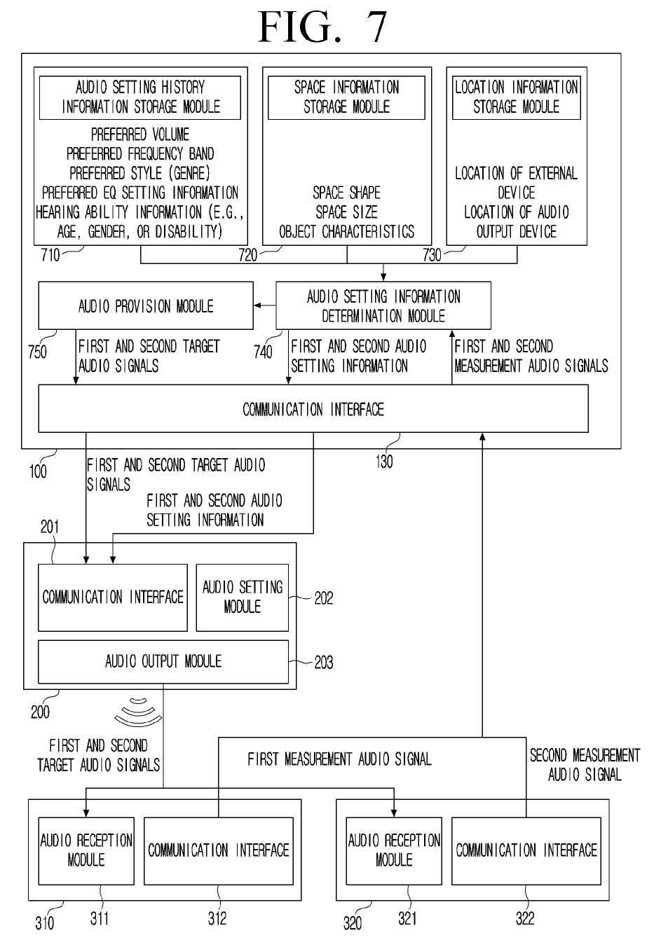

Additional descriptions related to the history information are described with reference to FIG. 7.

The communication interface 130 may communicate with the audio output device 200, the first external device 310 including a microphone, and the second external device 320 including a microphone. The microphone included in the first external device 310 and the microphone included in the second external device 320 may be separate components.

The electronic apparatus 100 may communicate with the first external device 310 and the second external device 320 based on a predetermined communication scheme. The predetermined communication scheme may be one of a Bluetooth communication scheme, an ultra-wideband (UWB) communication scheme, or a wireless fidelity (Wi-Fi) communication scheme.

The first external device 310 and the second external device 320 may be devices included in one group. The first external device 310 and the second external device 320 may each include a microphone.

For example, the first external device 310 may correspond to a left device of an earset, and the second external device 320 may correspond to a right device of the earset. The first external device 310 and the second external device 320 may be included in one earset.

For example, the first external device 310 may be a left part of a headset, and the second external device 320 may be a right part of the headset. The first external device 310 and the second external device 320 may be devices disposed in one headset. In relation to the headset, the first external device 310 and the second external device 320 may be described as a first part and a second part.

For example, the first external device 310 may be a first audio reception device, and the second external device 320 may be a second audio reception device. The first external device 310 and the second external device 320 may include different microphones from each other.

At least one processor 120 may control overall operations of the electronic apparatus 100. At least one processor 120 may perform a function of controlling overall operations of the electronic apparatus 100.

At least one processor 120 may: obtain first audio setting information based on the history information; transmit, to the audio output device 200, the first audio setting information and information related to a first target audio signal for testing; receive, from the first external device 310 through the communication interface 130, information related to a first measurement audio signal obtained by recording the information related to the first target audio signal output from the audio output device 200; receive, from the second external device 320 through the communication interface 130, information related to a second measurement audio signal obtained by recording the information related to the first target audio signal output from the audio output device 200; obtain second audio setting information based on the information related to the first measurement audio signal and the information related to the second measurement audio signal; and transmit, to the audio output device 200 through the communication interface 130, the second audio setting information and information related to a second target audio signal for a user.

The information related to the first target audio signal may be described as first target audio information or the first target audio signal.

The information related to the second target audio signal may be described as second target audio information or the second target audio signal.

The information related to the first measurement audio signal may be described as first measurement audio information or the first measurement audio signal.

The information related to the second measurement audio signal may be described as second measurement audio information or the second measurement audio signal.

Referring to FIGS. 7 to 25, information related to an audio signal is described as an audio signal. An operation for transmitting an audio signal does not indicate transmitting only the audio signal itself, and may indicate an operation for transmitting information including the audio signal.

At least one processor 120 may obtain (or generate) the first audio setting information related to an audio environment of the audio output device 200 based on the history information. The history information may indicate personal preference information of the user. At least one processor 120 may obtain the first audio setting information by applying the preference information of the user to the audio output device 200 based on the history information. At least one processor 120 may provide the first audio setting information to the audio output device 200.

For example, at least one processor 120 may obtain a preferred volume included in the history information. At least one processor 120 may obtain the first audio setting information including the preferred volume by applying the preferred volume to the audio output device 200. At least one processor 120 may transmit, to the audio output device 200, the first audio setting information including the preferred volume. The audio output device 200 may output an audio signal based on the preferred volume included in the first audio setting information. Although the preferred volume is described as an example, various information included in the history information may be equally applied to the audio output device 200.

At least one processor 120 may: obtain first location information of the first external device 310 and second location information of the second external device 320 based on a location of the electronic apparatus 100; and obtain the first audio setting information based on the history information, the first location information, and the second location information.

For example, at least one processor 120 may obtain the first location information and the second location information based on a predetermined communication scheme. At least one processor 120 may transmit a signal for requesting location information to each of the first external device 310 and the second external device 320. Each of the first external device 310 and the second external device 320 may transmit a response signal corresponding to the request signal to the electronic apparatus 100. At least one processor 120 may obtain the first location information based on a first response signal received from the first external device 310. At least one processor 120 may obtain the second location information based on a second response signal received from the second external device 320.

The electronic apparatus 100 may identify a location of the external device (or the terminal device) that transmits the response signal based on a measured strength of the response signal and a reception angle of the response signal. The response signal may include identification information of a device that transmits the response signal and an output strength of the response signal.

The response signal may decrease in strength by a predetermined ratio or a predetermined function as a distance increases. The electronic apparatus 100 may identify (or calculate) a distance between the electronic apparatus 100 and the external device (or the terminal device) that outputs the response signal by comparing the output strength included in the response signal with the measured strength obtained by analyzing the response signal.

For example, when the output strength is 100, the measured strength may be 50. The electronic apparatus 100 may identify locations of the electronic apparatus 100 and the external device (or the terminal device) that outputs the response signal based on a decreased value of 50.

The electronic apparatus 100 may sense a reception angle of the response signal. The electronic apparatus 100 may identify an output direction of the external device (or the terminal device) based on the reception angle of the response signal.

The electronic apparatus 100 may identify a location of the external device (or the terminal device) based on the measured strength of the response signal and the reception angle of the response signal. The electronic apparatus 100 may identify a relative location of the external device (or the terminal device) based on the location of the electronic apparatus 100.

For example, at least one processor 120 may obtain a captured image including a space in which the electronic apparatus 100 is disposed. At least one processor 120 may identify at least one of the first external device 310 or the second external device 320 in the captured image. At least one processor 120 may obtain the first location information of the first external device 310 and the second location information of the second external device 320 based on the captured image.

At least one processor 120 may obtain the first audio setting information based on the history information, the first location information, and the second location information.

For example, at least one processor 120 may determine a sound pressure level of the audio output device 200 by measuring an audio signal output from the audio output device 200 at a preferred volume included in the history information at a first coordinate corresponding to the first location information. At least one processor 120 may obtain the first audio setting information including the determined sound pressure level of the audio output device 200. The sound pressure level may be described as an audio magnitude, an audio intensity, an audio level, an audio output level, a volume, a sound volume level, or the like.

For example, at least one processor 120 may determine a sound pressure level of the audio output device 200 by measuring an audio signal output from the audio output device 200 at a preferred volume included in the history information at a second coordinate corresponding to the second location information. At least one processor 120 may obtain the first audio setting information including the determined sound pressure level of the audio output device 200.

At least one processor 120 may: obtain third location information of the audio output device 200; and obtain the first audio setting information based on the history information and the third location information.

At least one processor 120 may obtain the third location information of the audio output device 200. A method for identifying a location of the audio output device 200 may be the same as an operation for identifying locations of the first external device 310 and the second external device 320. Redundant descriptions thereof are thus omitted.

For example, at least one processor 120 may determine a sound pressure level of the audio output device 200 output at a third coordinate corresponding to the third location information to correspond to the preferred volume included in the history information. At least one processor 120 may obtain the first audio setting information including the determined sound pressure level of the audio output device 200.

At least one processor 120 may obtain the first audio setting information based on at least one of the history information, the first location information, the second location information, or the third location information.

For example, at least one processor 120 may determine a sound pressure level of the audio output device 200 by measuring an audio signal output at a third coordinate corresponding to the third location information at the preferred volume included in the history information at a first coordinate corresponding to the first location information. At least one processor 120 may obtain the first audio setting information including the determined sound pressure level of the audio output device 200.

For example, at least one processor 120 may determine a sound pressure level of the audio output device 200 by measuring an audio signal output at the third coordinate corresponding to the third location information at the preferred volume included in the history information at the second coordinate corresponding to the second location information. At least one processor 120 may obtain the first audio setting information including the determined sound pressure level of the audio output device 200.

The information related to the first target audio signal may include a test audio signal for obtaining the first audio setting information.

At least one processor 120 may obtain (or identify) the information related to the first target audio signal. The information related to the first target audio signal may include a signal output from the audio output device 200.

For example, the information related to the first target audio signal may be a test audio signal. The information related to the first target audio signal may be a test audio signal pre-stored in the memory 110. The test audio signal may vary depending on the number of audio output devices 200.

The processor 120 may determine a first test audio signal as the information related to the first target audio signal. When the audio output device 200 includes two speakers, at least one processor 120 may determine a second test audio signal as the information related to the first target audio signal. The information related to the first target audio signal corresponding to the audio output device 200 including a plurality of speakers may be an audio signal related to stereophonic sound.

For example, the information related to the first target audio signal may be an audio signal corresponding to a user input. When a user input for outputting a specific audio signal is received, at least one processor 120 may determine the specific audio signal as the information related to the first target audio signal.

At least one processor 120 may control the communication interface 130 to transmit the first audio setting information and the information related to the first target audio signal to the audio output device 200.

For example, at least one processor 120 may simultaneously transmit the first audio setting information and the information related to the first target audio signal to the audio output device 200. At least one processor 120 may group the first audio setting information and the information related to the first target audio signal into one communication packet, and may transmit the grouped communication packet to the audio output device 200.

For example, at least one processor 120 may control a first time point for transmitting the first audio setting information and a second time point for transmitting the information related to the first target audio signal to be different from each other. When the first time point and the second time point are different from each other, the first audio setting information and the information related to the first target audio signal may be transmitted to the audio output device 200 at different time points.

The audio output device 200 may receive the first audio setting information and the information related to the first target audio signal from at least one processor 120. The audio output device 200 may output the information related to the first target audio signal based on the first audio setting information. The audio output device 200 may include a speaker. The audio output device 200 may output the information related to the first target audio signal by applying the first audio setting information.

After the information related to the first target audio signal is obtained, at least one processor 120 may transmit a recording control command to the first external device 310 and the second external device 320. When the recording control command is received, the first external device 310 and the second external device 320 may perform a function of recording an audio signal. As the function of recording the audio signal is performed, the first external device 310 may obtain the information related to the first measurement audio signal, and the second external device 320 may obtain the information related to the second measurement audio signal.

A start time point at which the first external device 310 obtains the information related to the first measurement audio signal and a start time point at which the second external device 320 obtains the information related to the second measurement audio signal may be identical. The information related to the first measurement audio signal and the information related to the second measurement audio signal may be signals obtained by spatial sound (360-degree audio) measurement.

While the information related to the first target audio signal is output through the audio output device 200, the first external device 310 may obtain the information related to the first measurement audio signal through a microphone included in the first external device 310. The first external device 310 may transmit the information related to the first measurement audio signal to the electronic apparatus 100.

While the information related to the first target audio signal is output through the audio output device 200, the second external device 320 may obtain the information related to the second measurement audio signal through a microphone included in the second external device 320. The second external device 320 may transmit the information related to the second measurement audio signal to the electronic apparatus 100.

At least one processor 120 may receive, from the first external device 310 through the communication interface 130, the information related to the first measurement audio signal.

At least one processor 120 may receive, from the second external device 320 through the communication interface 130, the information related to the second measurement audio signal.

At least one processor 120 may obtain an analysis result by analyzing the information related to the first measurement audio signal and the information related to the second measurement audio signal. At least one processor 120 may obtain the second audio setting information based on the analysis result.

At least one processor 120 may use the information related to the first measurement audio signal and the information related to the second measurement audio signal to check a result in which the first audio setting information is applied to the audio output device 200.

At least one processor 120 may change the first audio setting information to the second audio setting information based on the information related to the first measurement audio signal and the information related to the second measurement audio signal.

For example, at least one processor 120 may obtain an predicted sound pressure level when the information related to the first target audio signal output based on the first audio setting information is recorded. At least one processor 120 may obtain a measured sound pressure level based on at least one of the information related to the first measurement audio signal or the information related to the second measurement audio signal. At least one processor 120 may obtain a difference value by comparing the predicted sound pressure level with the measured sound pressure level. At least one processor 120 may correct (or update) the first audio setting information to the second audio setting information based on the difference value.

The second audio setting information may include the EQ setting information, and the EQ setting information may include a first sound pressure level corresponding to a first frequency band and a second sound pressure level corresponding to a second frequency band.

The EQ setting information may indicate information for providing audio characteristics desired by the user by controlling an audio frequency. The EQ setting information may include a sound pressure level corresponding to each of a plurality of predetermined frequency bands. The EQ setting information may include a plurality of types, and different EQ setting information may be provided for each of the plurality of types.

The EQ setting information may include information related to at least one of a frequency band, a gain, a Q factor, a band type, or a filter.

The audio output device 200 may include the first audio output device 210 and the second audio output device 220, and the second audio setting information may include first stereophonic sound information corresponding to the first audio output device 210 and second stereophonic sound information corresponding to the second audio output device 220.

Stereophonic sound may include a technology in which a user feels a three-dimensional effect based on a temporal flow of an audio signal. The stereophonic sound may increase immersion in an audio environment by adjusting an audio direction, a distance, a height, or the like in a three-dimensional space.

Stereophonic sound may include a technology provided by using a location of each of a plurality of speakers. The plurality of speakers may indicate a plurality of devices included in the audio output device 200. Different stereophonic sound information may be provided for each of the plurality of audio output devices.

The stereophonic sound information may include at least one of a three-dimensional (3D) audio codec or a spatial audio algorithm. The three-dimensional (3D) audio codec may include a codec used for encoding and decoding an audio signal. The spatial audio algorithm may include an algorithm for simulating a phenomenon in which an audio signal is transmitted, reflected, attenuated, and diffracted at a specific location.

According to various embodiments, the first external device 310 and the second external device 320 may record an audio signal through the microphones. Each of the first external device 310 and the second external device 320 may perform a noise canceling function while recording an audio signal.

The information related to the first measurement audio signal may include a signal obtained while the noise canceling function is performed in the first external device 310, and the information related to the second measurement audio signal may include a signal obtained while the noise canceling function is performed in the second external device 320.

The first external device 310 may obtain the information related to the first measurement audio signal while performing the noise canceling function.

The second external device 320 may obtain the information related to the second measurement audio signal while performing the noise canceling function.

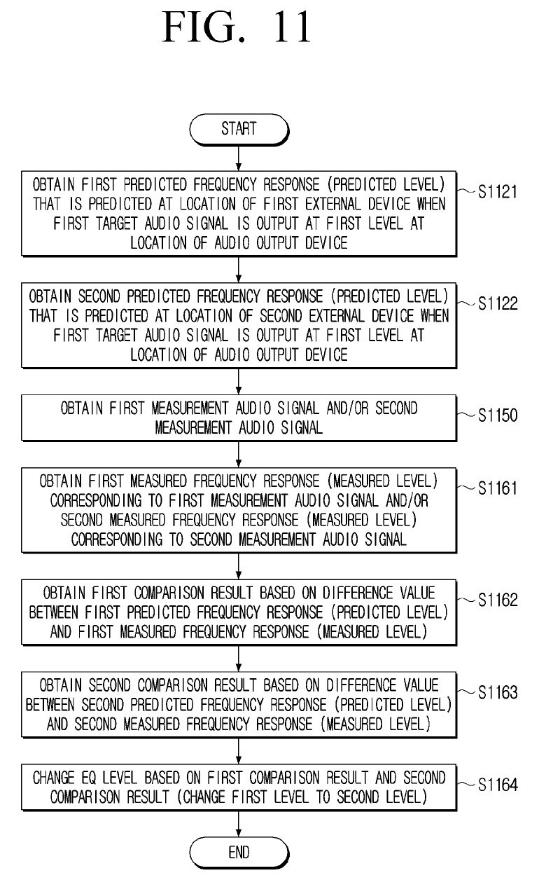

At least one processor 120 may: obtain a first predicted frequency response that is predicted at a location of the first external device when the first target audio signal is output from the audio output device; obtain a first measured frequency response (measured level) corresponding to the first measurement audio signal; obtain a difference value between the first predicted frequency response and the first measured frequency response (measured level); and obtain the second audio setting information by applying the difference value to the first audio setting information. Additional descriptions related thereto are provided with reference to FIG. 11.

At least one processor 120 may: obtain space information including characteristics of a space in which the electronic apparatus is disposed; and obtain the first audio setting information based on the history information and the space information, and the space information may include at least one of a space shape or a space size. Additional descriptions related thereto are provided with reference to FIG. 3.

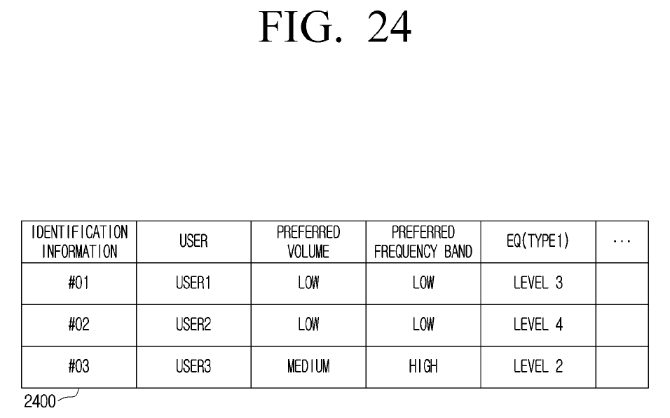

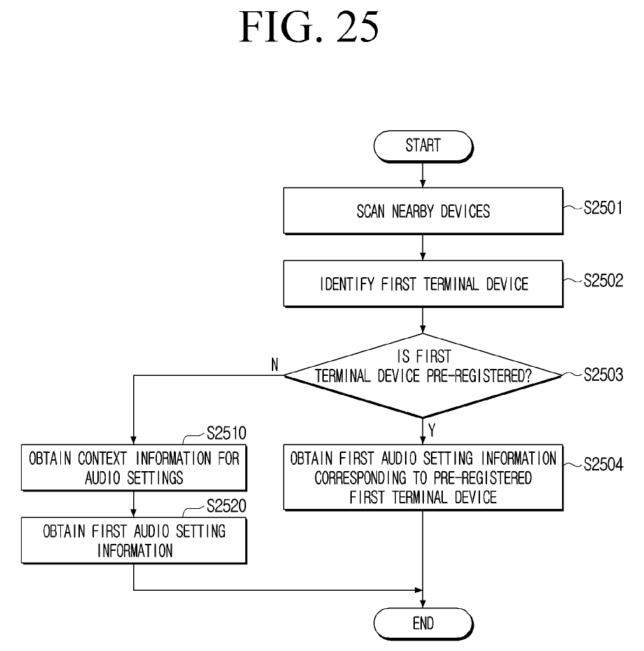

At least one processor 120 may: obtain user identification information corresponding to the first external device or the second external device; and obtain the history information corresponding to the identification information from among a plurality of user-specific history information stored in the memory. Additional descriptions related thereto are provided with reference to FIGS. 24 and 25.

According to various embodiments, the electronic apparatus 100 may identify whether the first external device 310 and the second external device 320 are simultaneously activated.

The electronic apparatus 100 may obtain the first audio setting information or the second audio setting information based on an activated state of at least one of the first external device 310 or the second external device 320.

In an embodiment, the first external device 310 is worn on a left side of the user based on a direction in which the user faces the audio output device 200. In an embodiment, the second external device 320 is worn on a right side of the user based on the direction in which the user faces the audio output device 200.

The electronic apparatus 100 may determine a reference location of stereophonic sound based on the activated state of at least one of the first external device 310 or the second external device 320.

For example, only the first external device 310 may be activated. The electronic apparatus 100 may identify that the first external device 310 is in an activated state. The electronic apparatus 100 may obtain setting information related to stereophonic sound based on location information of the first external device 310.

In another example, only the second external device 320 may be activated. The electronic apparatus 100 may identify that the second external device 320 is in an activated state. The electronic apparatus 100 may obtain setting information related to stereophonic sound based on location information of the second external device 320.

For example, both the first external device 310 and the second external device 320 may be activated. The electronic apparatus 100 may identify that both the first external device 310 and the second external device 320 are in the activated state. The electronic apparatus 100 may obtain the setting information related to stereophonic sound by considering both of the location information of the first external device 310 and the location information of the second external device 320.

According to various embodiments, the electronic apparatus 100 may adjust an EQ level of the audio output device 200 or adjust music intensity for each frequency based on user preferred sound.

According to various embodiments, the electronic apparatus 100 may optimize stereophonic sound tuning by performing a direction recognition test function of the audio output device 200.

According to various embodiments, the first target audio signal and the second target audio signal may be identical. For example, the first target audio signal and the second target audio signal may both be audio content provided to the user.

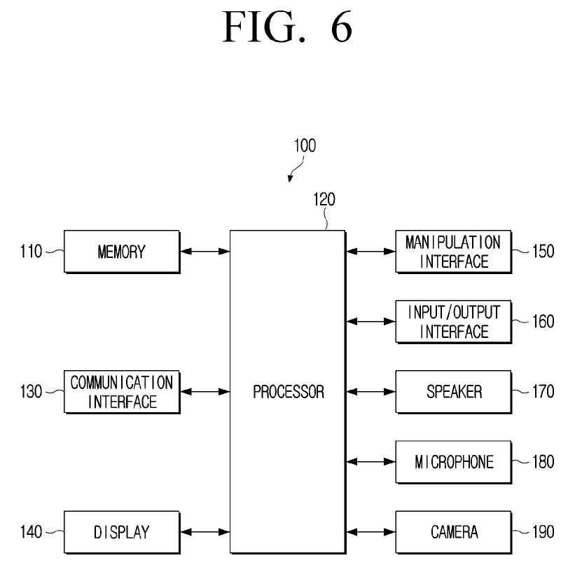

FIG. 6 illustrates a detailed configuration of the electronic apparatus illustrated in FIG. 5 according to an embodiment.

Referring to FIG. 6, the electronic apparatus 100 may include at least one of the memory 110, at least one processor 120, the communication interface 130, a display 140, a manipulation interface 150, an input/output interface 160, a speaker 170, a microphone 180, or a camera 190.

The memory 110 may be implemented as an internal memory such as a read-only memory (ROM) (e.g., an electrically erasable programmable read-only memory (EEPROM) or a random access memory (RAM) included in the at least one processor 120, or may be implemented as a memory separate from the at least one processor 120. The memory 110 may be implemented as the memory embedded in the electronic apparatus 100 or the memory detachable from the electronic apparatus 100 based on a data storage purpose. For example, data for driving the electronic apparatus 100 may be stored in the memory embedded in the electronic apparatus 100, and data for extended functions of the electronic apparatus 100 may be stored in the memory detachable from the electronic apparatus 100.

The memory embedded in the electronic apparatus 100 may be implemented as at least one of a volatile memory (e.g., a dynamic random access memory (DRAM), a static random access memory (SRAM), or a synchronous dynamic random access memory (SDRAM)) or a non-volatile memory (e.g., a one-time programmable read-only memory (OTPROM), a programmable read-only memory (PROM), an erasable and programmable read-only memory (EPROM), an electrically erasable and programmable read-only memory (EEPROM), a mask ROM, a flash ROM, a flash memory (e.g., a NAND flash or a NOR flash), a hard drive, or a solid state drive (SSD)); and the memory detachable from the electronic apparatus 100 may be implemented as a memory card (e.g., a compact flash (CF), a secure digital (SD), a micro secure digital (Micro-SD), a mini secure digital (Mini-SD), an extreme digital (xD), or a multi-media card (MMC)) or an external memory connectable to a universal serial bus (USB) port (e.g., a USB memory).

The memory 110 may store at least one instruction. At least one processor 120 may perform various operations based on the instruction stored in the memory 110.

At least one processor 120 may be implemented as a digital signal processor (DSP), a microprocessor, or a time controller (TCON) for processing digital signals. However, the present disclosure is not limited thereto, and at least one processor 120 may include or be defined as at least one of a central processing unit (CPU), a micro controller unit (MCU), a micro processing unit (MPU), a controller, an application processor (AP), a graphics processing unit (GPU), a communication processor (CP), or an advanced reduced instruction set computer (RISC) machines (ARM) processor. At least one processor 120 may be implemented as a system-on-chip (SoC) or a large scale integration (LSI) in which a processing algorithm is embedded, or may be implemented as a field programmable gate array (FPGA). At least one processor 120 may perform various functions by executing computer executable instructions stored in the memory.

The communication interface 130 may be a component for performing communication with various types of external devices according to various types of communication schemes. The communication interface 130 may include a wireless communication module or a wired communication module. Each communication module may be implemented as at least one hardware chip.

The wireless communication module may refer to a module for performing communication with an external device in a wireless manner. For example, the wireless communication module may include at least one of a wireless-fidelity (Wi-Fi) module, a Bluetooth module, an infrared communication module, or another communication module.

The Wi-Fi module and the Bluetooth module may perform communication in a Wi-Fi scheme and a Bluetooth scheme, respectively. When using the Wi-Fi module or the Bluetooth module, various connection information such as a service set identifier (SSID) and a session key may first be transmitted and received to establish communication connection by using the connection information, and various types of information may then be transmitted and received.

The infrared communication module may perform communication according to an infrared communication (IrDA, infrared Data Association) technology for transmitting data over a short distance in a wireless manner using infrared rays located between visible light and millimeter waves.

Another communication module may include at least one communication chip that performs communication according to various wireless communication standards such as ZigBee, third generation (3G), third generation partnership project (3GPP), long term evolution (LTE), LTE advanced (LTE-A), fourth generation (4G), and fifth generation (5G), in addition to the above-described communication schemes.

The wired communication module may refer to a module for performing communication with an external device in a wired manner. For example, the wired communication module may include at least one of a local region network (LAN) module, an Ethernet module, a pair cable, a coaxial cable, an optical fiber cable, or an ultrawide band (UWB) module.

According to various embodiments, the communication interface 130 may use the same communication module (e.g., the Wi-Fi module) to communicate with an external device such as a remote control device or an external server.

According to various embodiments, the communication interface 130 may use different communication modules to communicate with the external device such as the remote control device or the external server. For example, the communication interface 130 may use at least one of the Ethernet module or the Wi-Fi module to communicate with the external server, and may use the Bluetooth module to communicate with the external device such as the remote control device. However, this configuration is merely an embodiment, and when communicating with a plurality of external devices or external servers, the communication interface 130 may use at least one communication module among various communication modules.

The display 140 may be implemented as various types of displays such as a liquid crystal display (LCD), an organic light-emitting diode (OLED) display, or a plasma display panel (PDP). The display 140 may further include a driving circuit, a backlight unit, or the like together, which may be implemented as an amorphous silicon thin film transistor (a-si TFT), a low temperature poly silicon (LTPS) TFT, or an organic TFT (OTFT). The display 140 may be implemented as a touch screen combined with a touch sensor, a flexible display, or a three-dimensional display (3D display). According to an embodiment of the present disclosure, the display 140 may include not only a display panel for outputting an image, but also a bezel housing the display panel. In particular, according to an embodiment of the present disclosure, the bezel may include a touch sensor for detecting a user interaction.

The manipulation interface 150 may be implemented as a device such as a button, a touch pad, a mouse, or a keyboard, or may be implemented as a touch screen capable of performing the above-described display function and a manipulation input function together. The button may be implemented as various types of buttons such as a mechanical button, a touch pad, or a wheel formed in an arbitrary region such as the front portion, side portion, or rear portion of an exterior of a main body of the electronic apparatus 100.

The input/output interface 160 may be implemented as one of interfaces such as a high-definition multimedia interface (HDMI), a mobile high-definition link (MHL), a universal serial bus (USB), a DisplayPort (DP), a Thunderbolt, a video graphics array (VGA) port, a red-green-blue (RGB) port, a D-subminiature (D-SUB), or a digital visual interface (DVI). The input/output interface 160 may input and output at least one of an audio signal or a video signal. According to an implementation example, the input/output interface 160 may include a port for inputting and outputting only the audio signal and a port for inputting and outputting only the video signal as separate ports, or may be implemented as one port for inputting and outputting both the audio signal and the video signal. The electronic apparatus 100 may transmit at least one of the audio signal or the video signal to an external device (e.g., an external display apparatus or an external speaker) through the input/output interface 160. An output port included in the input/output interface 160 may be connected to the external device, and the electronic apparatus 100 may transmit at least one of the audio signal or the video signal to the external device through the output port.

The input/output interface 160 may be connected to the communication interface. The input/output interface 160 may transmit information received from the external device to the communication interface or transmit information received through the communication interface to the external device.

The speaker 170 may be a component for outputting various types of audio data, as well as various notification sounds, voice messages, or the like.

The microphone 180 may be a component for receiving a user voice or other sounds and converting the same into audio data. The microphone 180 may receive a user voice in an activated state. For example, the microphone 180 may be integrally formed on the upper surface, front surface, or side surface of the electronic apparatus 100. The microphone 180 may include various configurations such as a microphone for collecting an analog user voice, an amplifier circuit for amplifying the collected user voice, an analog-to-digital (A/D) conversion circuit for sampling the amplified user voice and converting the amplified user voice into a digital signal, and a filter circuit for removing noise components from the converted digital signal.

The camera 190 may be a component for capturing an image of a subject to generate a captured image, and the captured image refers to a concept including both a moving image and a still image. The camera 190 may acquire an image of at least one external device, and may be implemented as a camera, a lens, an infrared sensor, or the like.

The camera 190 may include a lens and an image sensor. Types of the lens may include a general-purpose lens, a wide-angle lens, a zoom lens, or the like, and may be determined based on the type, characteristics, or usage environment of the electronic apparatus 100. The image sensor may use a complementary metal oxide semiconductor (CMOS) or a charge coupled device (CCD), or the like.

FIG. 7 illustrates an operation for providing audio setting information according to an embodiment.

Referring to FIG. 7, the electronic apparatus 100 may store audio context information. The context information may include at least one of audio setting history information, the space information, or the location information.

The electronic apparatus 100 may include at least one of a storage module 710 related to the audio setting history information, a storage module 720 related to the space information, a storage module 730 related to the location information, a determination module 740 related to the audio setting information, or an audio provision module 750. Each module may be described as a first module, a second module, a third module, a fourth module, a fifth module, or the like. Ordinals may be changed.

The storage module 710 related to the audio setting history information may store user history information related to audio setting. The history information may include at least one of a preferred volume, a preferred frequency band, a preferred style (or a genre), preferred equalizer (EQ) information, or hearing ability information.

The preferred volume may indicate an average value of an audio volume (or a level or a volume) selected by the user.

The preferred frequency band may indicate an average value of an audio frequency band selected (or listened to) by the user.

The preferred style (or a genre) may indicate a style of audio selected by the user (or style information).

The preferred equalizer (EQ) information may indicate an audio-related EQ setting selected by the user.

The hearing ability information may include at least one of a user age, a user gender, or hearing impairment information. The hearing ability information may include an audible frequency range corresponding to the user age. As the user age increases, the audible frequency range may decrease.

The storage module 720 related to the space information may store information related to a space in which the audio output device 200 is disposed. The space information may include at least one of a space shape, a space size, or object characteristics. The object may indicate an object identified in the space. The object characteristics may indicate classification criteria representing the identified object. For example, the object characteristics may indicate an obstacle, a person, or the like.

The electronic apparatus 100 may use a sensor for obtaining the space information.

For example, the sensor may be an image sensor. The image sensor may include the camera 190. The electronic apparatus 100 may obtain a captured image through the camera 190. The electronic apparatus 100 may obtain space information of an environment in which the electronic apparatus 100 is disposed based on the captured image.

The electronic apparatus 100 may use a sensor to obtain location information. The electronic apparatus 100 may sense the location information of the first external device 310 and/or the location information of the second external device 320 by using distance sensors respectively included in the first external device 310 and/or the second external device 320.

The electronic apparatus 100 may be connected to each of the audio output device 200, the first external device 310, and the second external device 320 by using a predetermined communication scheme. The electronic apparatus 100 may obtain each location information based on the predetermined communication scheme. The predetermined communication scheme may be one of the Bluetooth communication scheme, the ultra-wideband (UWB) communication scheme, or the Wi-Fi communication scheme.

The storage module 730 related to the location information may store at least one of a location of the external device or a location of the audio output device. The storage module 730 related to the location information may store at least one of the location information of the audio output device 200, the location information of the first external device 310, or the location information of the second external device 320.

According to various embodiments, the electronic apparatus 100 may identify a location of an external device. The electronic apparatus 100 may perform communication with the external device, and may output a request signal for identifying the location of the external device in a communication process with the external device. The external device may transmit a response signal corresponding to the request signal. The electronic apparatus 100 may obtain the location information of the external device based on the response signal transmitted from the external device.

According to various embodiments, the electronic apparatus 100 may identify a user location. The electronic apparatus 100 may obtain a captured image by using a camera, and may identify the user location based on the captured image. When the user is identified, the electronic apparatus 100 may store the user location in the storage module 730 related to the location information.

According to various embodiments, the electronic apparatus 100 may determine the location of the external device as the user location.

The determination module 740 related to the audio setting information may obtain (or determine or identify) the first audio setting information based on the context information. The electronic apparatus 100 may obtain the first audio setting information based on at least one of the history information related to audio settings, the space information, the location information of the external device, or the location information of the audio output device. The determination module 740 related to the audio setting information may transmit the first audio setting information to the audio provision module 750. The determination module 740 related to the audio setting information may transmit the first audio setting information to the audio output device 200 through the communication interface 130. The audio provision module 750 may be described as an audio signal determination module.

The audio provision module 750 may determine the first target audio signal to be transmitted to the audio output device 200. The audio provision module 750 may identify the first target audio signal based on the first audio setting information. The audio provision module 750 may obtain the first target audio signal appropriate for a location of the audio output device 200 included in the first audio setting information. The audio provision module 750 may transmit the first target audio signal to the audio output device 200 through the communication interface 130.

The audio output device 200 may include at least one of a communication interface 201, an audio setting module 202, or an audio output module 203. The audio output device 200 may receive the first audio setting information and the first target audio signal from the electronic apparatus 100 through the communication interface 201. The audio output device 200 may store and set the first audio setting information through the audio setting module 202. The audio output device 200 may output the first target audio signal through the audio output module 203. The audio output device 200 may output the first target audio signal based on the first audio setting information. The audio output module 203 may include a speaker.

The first target audio signal output through the audio output device 200 may be obtained by the first external device 310 and the second external device 320.

The first external device 310 may include at least one of an audio reception module 311 or a communication interface 312. The audio reception module 311 may include a microphone. The first external device 310 may obtain the first measurement audio signal by recording the first target audio signal through the audio reception module 311. The first external device 310 may transmit the first measurement audio signal to the electronic apparatus 100 through the communication interface 312.

The second external device 320 may include at least one of an audio reception module 321 or a communication interface 322. The audio reception module 321 may include a microphone. The second external device 320 may obtain the second measurement audio signal by recording the first target audio signal through the audio reception module 321. The second external device 320 may transmit the second measurement audio signal to the electronic apparatus 100 through the communication interface 322.

The electronic apparatus 100 may receive the first measurement audio signal from the first external device 310 through the communication interface 130. The electronic apparatus 100 may receive the second measurement audio signal from the second external device 320 through the communication interface 130.

The determination module 740 related to the audio setting information may obtain the second audio setting information based on the first measurement audio signal and the second measurement audio signal. The electronic apparatus 100 may change (or update) the first audio setting information to the second audio setting information by analyzing the first measurement audio signal and the second measurement audio signal.

The determination module 740 related to the audio setting information may obtain the second audio setting information based on the first target audio signal, the first measurement audio signal, and the second measurement audio signal.

The determination module 740 related to the audio setting information may determine the second audio setting information based on the first target audio signal, the first measurement audio signal, the second measurement audio signal, and the context information. The determination module 740 related to the audio setting information may transmit the second audio setting information to the audio provision module 750. The determination module 740 related to the audio setting information may transmit the second audio setting information to the audio output device 200 through the communication interface 130.

The audio provision module 750 may determine the second target audio signal to be transmitted to the audio output device 200. The audio provision module 750 may identify the second target audio signal based on the second audio setting information. The audio provision module 750 may obtain the second target audio signal appropriate for a location of the audio output device 200 included in the second audio setting information. The audio provision module 750 may transmit the second target audio signal to the audio output device 200 through the communication interface 130.

The audio output device 200 may receive the second audio setting information and the second target audio signal from the electronic apparatus 100 through the communication interface 201. The audio output device 200 may store and set the second audio setting information through the audio setting module 202. The audio output device 200 may output the second target audio signal through the audio output module 203. The audio output device 200 may output the second target audio signal based on the second audio setting information.

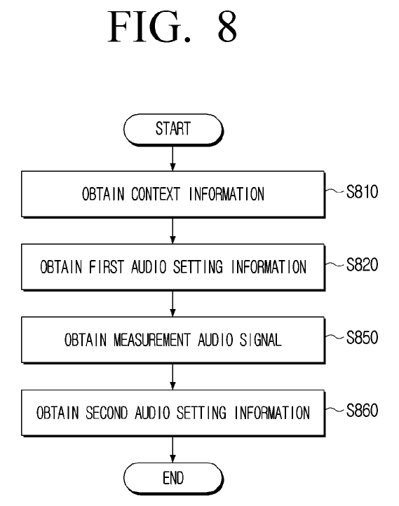

FIG. 8 illustrates an operation for obtaining audio setting information according to an embodiment.

Referring to FIG. 8, the electronic apparatus 100 may obtain the context information (S810). The context information may include at least one of the audio setting history information, the space information, or the location information.

The electronic apparatus 100 may obtain the first audio setting information (S820). The electronic apparatus 100 may obtain the first audio setting information based on the context information. The electronic apparatus 100 may provide the first target audio signal based on the first audio setting information.

For example, an operation for providing the first target audio signal may include transmitting the first target audio signal to the audio output device 200. The audio output device 200 may output the first target audio signal based on the first audio setting information.

For example, the operation for providing the first target audio signal may include outputting the first target audio signal through the speaker 170. The electronic apparatus 100 may output the first target audio signal directly through the speaker 170.

The electronic apparatus 100 may obtain the measurement audio signal (S850). The electronic apparatus 100 may obtain the measurement audio signal obtained by recording the output first target audio signal.

For example, the electronic apparatus 100 may obtain, from the external device, the measurement audio signal recorded through the microphone included in the external device.

For example, the electronic apparatus 100 may obtain the measurement audio signal recorded through the microphone 180 included in the electronic apparatus 100.

The electronic apparatus 100 may obtain the second audio setting information (S860). The electronic apparatus 100 may obtain the second audio setting information by analyzing the measurement audio signal. The electronic apparatus 100 may obtain the second audio setting information after obtaining the first audio setting information. The electronic apparatus 100 may change the first audio setting information to the second audio setting information.

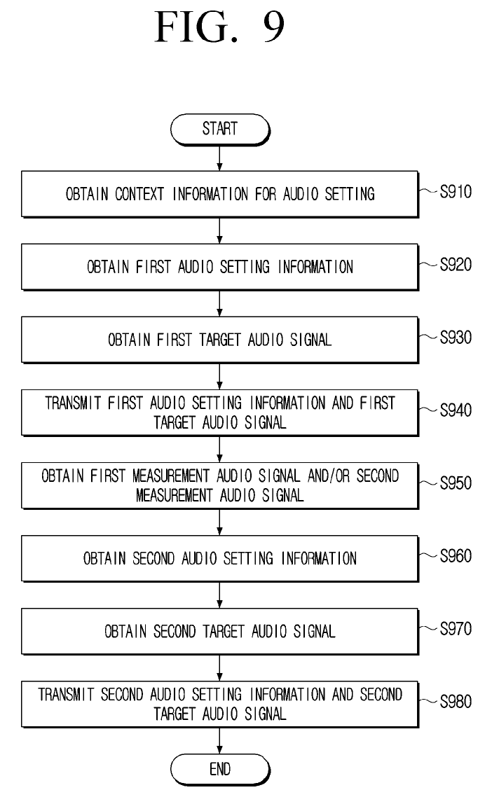

FIG. 9 illustrates the operation of obtaining audio setting information according to an embodiment.

Operations S910, S920, S950, and S960 of FIG. 9 may correspond to operations S810, S820, S850, and S860 of FIG. 8. Redundant descriptions thereof are thus omitted.

The electronic apparatus 100 may obtain the context information for audio setting (S910).

The electronic apparatus 100 may obtain the first audio setting information (S920). The electronic apparatus 100 may obtain the first audio setting information based on the context information.

The electronic apparatus 100 may obtain the first target audio signal (S930). The electronic apparatus 100 may obtain the first target audio signal based on the first audio setting information. The electronic apparatus 100 may obtain the first target audio signal based on the context information and the first audio setting information. The first target audio signal may indicate an audio signal to be output through the audio output device 200. The first target audio signal may be a pre-stored test audio signal. The test audio signal may vary depending on the number of speakers included in the audio output device 200.

The electronic apparatus 100 may transmit the first audio setting information and the first target audio signal to the audio output device 200 (S940). The electronic apparatus 100 and the audio output device 200 may be communicatively connected to each other.

The electronic apparatus 100 may obtain the first measurement audio signal and/or the second measurement audio signal after transmitting the first target audio signal to the audio output device 200 (S950). The electronic apparatus 100 may receive the first measurement audio signal from the first external device 310. The electronic apparatus 100 may receive the second measurement audio signal from the second external device 320.

The electronic apparatus 100 may obtain the second audio setting information (S960). The electronic apparatus 100 may obtain the second audio setting information based on at least one of the first measurement audio signal or the second measurement audio signal. The first measurement audio signal and the second measurement audio signal may be signals recorded by using the microphones included in the first external device 310 and the second external device 320, rather than the electronic apparatus 100. The first external device 310 and the second external device 320 may be an earset carried by the user. The first measurement audio signal and the second measurement audio signal recorded by each of the first external device 310 and the second external device 320 may be signals measured at the user location.

The electronic apparatus 100 may obtain (or identify) the second audio setting information appropriate for the user by analyzing at least one of the first measurement audio signal or the second measurement audio signal.

The electronic apparatus 100 may obtain the second target audio signal (S970). The electronic apparatus 100 may obtain the second target audio signal based on the second audio setting information. The electronic apparatus 100 may obtain the second target audio signal based on the context information and the second audio setting information. The second target audio signal may indicate an audio signal to be output through the audio output device 200. The second target audio signal may indicate content to be listened to through the audio output device 200.

The electronic apparatus 100 may transmit the second audio setting information and the second target audio signal to the audio output device 200 (S980).

The transmitting operations performed in operations S940 and S980 may use the Bluetooth communication scheme, the ultra-wideband (UWB) communication scheme, or the Wi-Fi communication scheme.

According to various embodiments, the transmitting operation performed in operation S940 may correspond to the Bluetooth communication scheme (or the Wi-Fi communication scheme), and the transmitting operation performed in operation S980 may correspond to the Wi-Fi communication scheme (or the Bluetooth communication scheme).

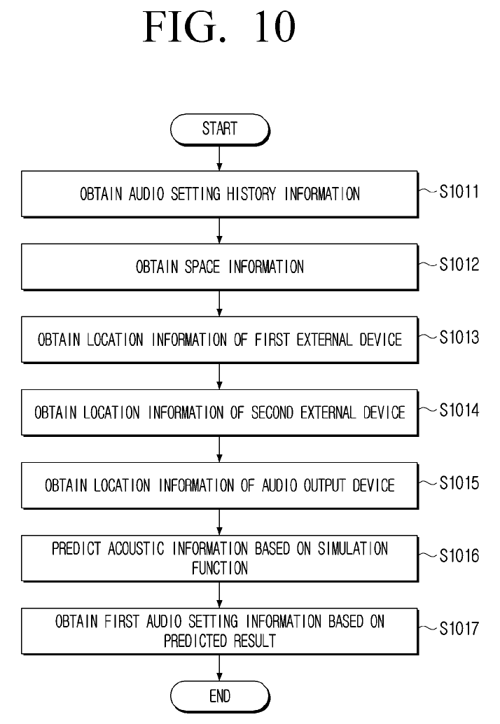

FIG. 10 illustrates an operation for obtaining first audio setting information according to an embodiment.

Referring to FIG. 10, the electronic apparatus 100 may obtain the audio setting history information (S1011). The audio setting history information may be described as the history information related to audio settings. The history information may include the past history of audio settings provided to the user.

The electronic apparatus 100 may obtain the space information (S1012). The space information may include information related to a space. The space information may include at least one of the space shape, the space size, or the object characteristics. The object may indicate an object identified in the space. The object characteristics may indicate the classification criteria representing the identified object. For example, the object characteristics may indicate an obstacle, a person, or the like.

The electronic apparatus 100 may obtain the location information of the first external device 310 (S1013). The electronic apparatus 100 may obtain the location information of the second external device 320 (S1014). The electronic apparatus 100 may obtain the location information of the audio output device 200 (S1015). An order of operations S1013, S1014, and S1015 may be changed.

According to an embodiment, the electronic apparatus 100 may obtain the location information by using a predetermined communication scheme. The electronic apparatus 100 may transmit the request signal for determining a location. The electronic apparatus 100 may broadcast the request signal. The first external device 310, the second external device 320, and the audio output device 200 may transmit, to the electronic apparatus 100, the response signal in response to the request signal. The electronic apparatus 100 may obtain, based on the response signal, the location information of each of the first external device 310, the second external device 320, and the audio output device 200. Each location information may be described as the first location information, the second location information, and the third location information. Ordinals may be changed.

According to an embodiment, the electronic apparatus 100 may obtain a captured image of surroundings of the electronic apparatus 100 through the camera 190. The electronic apparatus 100 may obtain, based on the captured image, the location information of each of the first external device 310, the second external device 320, and the audio output device 200. The electronic apparatus 100 may identify the first external device 310, the second external device 320, and the audio output device 200 in the captured image, and may obtain each location information by analyzing the location of each of the identified first external device 310, the identified second external device 320, and the identified audio output device 200.

The electronic apparatus 100 may predict acoustic information based on a simulation function (S1016). The simulation function may indicate a function of predicting an acoustic perception result of an audio signal without actually outputting the audio signal. The simulation function may be performed based on an artificial intelligence model. The artificial intelligence model may obtain the context information as input data and may output the audio setting information as output data.

The electronic apparatus 100 may obtain the first audio setting information based on a predicted result of the simulation (S1017). The electronic apparatus 100 may obtain the first audio setting information based on a result of operation S1016.

FIG. 11 illustrates an operation for obtaining first audio setting information according to an embodiment.

Operation S1150 of FIG. 11 may correspond to operation S950 of FIG. 9. A redundant description thereof is thus omitted.

The electronic apparatus 100 may obtain the first predicted frequency response (predicted level) that is predicted at a location of the first external device 310 when the first target audio signal is output at a first level at a location of the audio output device 200 (S1121). The first level may indicate magnitude information of a specific frequency being output. The level may be described as sound pressure, volume, intensity, strength, or the like.

The electronic apparatus 100 may obtain a predicted level related to an intensity of an audio signal based on the predicted frequency response. For example, an audio signal of 100 dB is output from a speaker at a location 10 m away from the electronic apparatus 100. The electronic apparatus 100 may predict that the audio signal is obtained at 80 dB based on the predicted frequency response.

One target audio signal may be output for one frequency band. Target audio signals respectively corresponding to a plurality of frequency bands may be output. Output levels of the plurality of frequency bands may be different from each other.

The electronic apparatus 100 may obtain a second predicted frequency response (predicted level) that is predicted at a location of the second external device 320 when the first target audio signal is output at the first level at the location of the audio output device 200 (S1122).

After the first target audio signal is output, the electronic apparatus 100 may obtain at least one of the first measurement audio signal or the second measurement audio signal (S1150).

The electronic apparatus 100 may obtain the first measured frequency response (measured level) corresponding to the first measurement audio signal and/or a second measured frequency response (measured level) corresponding to the second measurement audio signal (S1161).

The electronic apparatus 100 may obtain the measured frequency response based on the measurement audio signal. The electronic apparatus 100 may identify the measured level indicating the intensity of an audio signal based on the measured frequency response. The electronic apparatus 100 may compare the predicted level with the measured level.

The electronic apparatus 100 may obtain a first comparison result based on the difference value between the first predicted frequency response (predicted level) and the first measured frequency response (measured level) (S1162).

The electronic apparatus 100 may obtain a second comparison result based on the difference value between the second predicted frequency response (predicted level) and the second measured frequency response (measured level) (S1163).

The electronic apparatus 100 may change the EQ level based on the first comparison result and the second comparison result (S1164). The electronic apparatus 100 may change the first level to a second level.

Based on the difference value between the predicted level and the measured level, the electronic apparatus 100 may obtain the audio setting information related to the audio output device 200. The audio setting information may include the EQ setting information.

When the difference value obtained by subtracting the predicted level from the measured level is greater than or equal to a first threshold value (positive), the electronic apparatus 100 may change the audio setting information (EQ setting information) to output an audio signal at the second level lower than the first level.

When the difference value obtained by subtracting the predicted level from the measured level is less than a second threshold value (negative), the electronic apparatus 100 may change the audio setting information (EQ setting information) to output an audio signal at a third level greater than the first level.

When the difference value obtained by subtracting the predicted level from the measured level is less than the first threshold value (positive) or greater than or equal to the second threshold value (negative), the electronic apparatus 100 may maintain the first level. The electronic apparatus 100 may not change the audio setting.

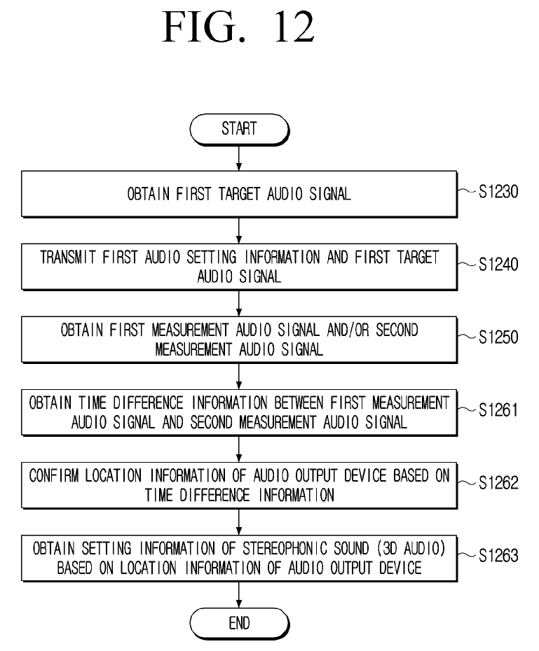

FIG. 12 illustrates an operation for obtaining first audio setting information according to an embodiment.

Operations S1230, S1240, and S1250 of FIG. 12 may correspond to operations S930, S940, and S950 of FIG. 9. Redundant descriptions thereof are thus omitted.

After obtaining the first measurement audio signal and/or the second measurement audio signal, the electronic apparatus 100 may obtain time difference information between the first measurement audio signal and the second measurement audio signal (S1261).

The first measurement audio signal may be a signal recorded by the first external device 310. The second measurement audio signal may be a signal recorded by the second external device 320. Based on a location difference between the first external device 310 and the second external device 320, reception time points of the same sound source (or the same signal pattern) may be different. A difference in reception time points may be included in the time difference information. The time difference information may include time delay information.

The electronic apparatus 100 may obtain the location information of the audio output device 200 based on the time difference information (S1262).

The electronic apparatus 100 may obtain setting information of stereophonic sound (3D audio) based on the location information of the audio output device 200 (S1263). Stereophonic sound may include a technology in which the user feels a stereoscopic effect based on a temporal flow of an audio signal. Stereophonic sound may increase immersion in an audio environment by adjusting an audio direction, a distance, and a height in a three-dimensional space.

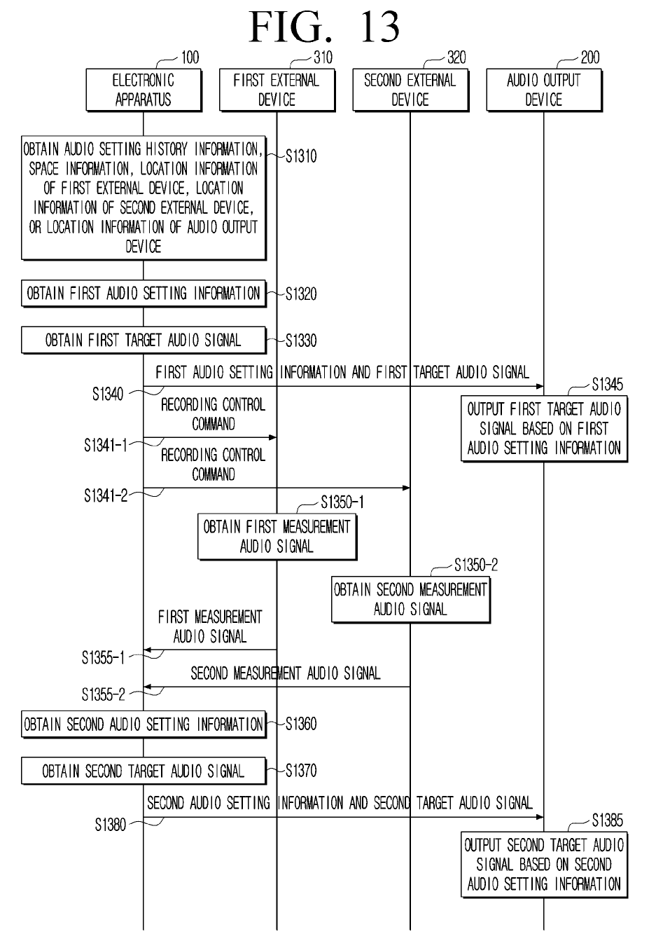

FIG. 13 illustrates an operation for providing audio setting information by using a plurality of external devices according to an embodiment.

Operations S1310, S1320, S1330, S1340, S1360, S1370, and S1380 of FIG. 13 may correspond to operations S910, S920, S930, S940, S960, S970, and S980 of FIG. 9. Redundant descriptions thereof are thus omitted.

The electronic apparatus 100 may obtain the context information including at least one of the audio setting history information, the space information, the location information of the first external device 310, the location information of the second external device 320, or the location information of the audio output device 200 (S1310).

The electronic apparatus 100 may obtain the first audio setting information based on the context information (S1320). The electronic apparatus 100 may obtain the first target audio signal (S1330). The electronic apparatus 100 may transmit the first audio setting information and the first target audio signal to the audio output device 200 (S1340).

After the first target audio signal is obtained, the electronic apparatus 100 may transmit the recording control command to the first external device 310 (S1341-1). After the first target audio signal is obtained, at least one processor 120 may transmit the recording control command to the second external device 320 (S1341-2). The first external device 310 and the second external device 320 may record an audio signal based on the recording control command.

The audio output device 200 may receive the first audio setting information and the first target audio signal from the electronic apparatus 100. The audio output device 200 may output the first target audio signal based on the first audio setting information (S1345).

The first external device 310 may obtain the first measurement audio signal based on the output first target audio signal (S1350-1). The first external device 310 may transmit the first measurement audio signal to the electronic apparatus 100 (S1355-1).

The second external device 310 may obtain the second measurement audio signal based on the output first target audio signal (S1350-2). The second external device 310 may transmit the second measurement audio signal to the electronic apparatus 100 (S1355-2).

The electronic apparatus 100 may receive the first measurement audio signal from the first external device 310. The electronic apparatus 100 may receive the second measurement audio signal from the second external device 320.

The electronic apparatus 100 may obtain the second audio setting information based on at least one of the first measurement audio signal or the second measurement audio signal (S1360). The electronic apparatus 100 may obtain the second target audio signal (S1370). The electronic apparatus 100 may transmit the second audio setting information and the second target audio signal to the audio output device 200 (S1380).

The audio output device 200 may receive the second audio setting information and the second target audio signal from the electronic apparatus 100. The audio output device 200 may output the second target audio signal based on the second audio setting information (S1385).

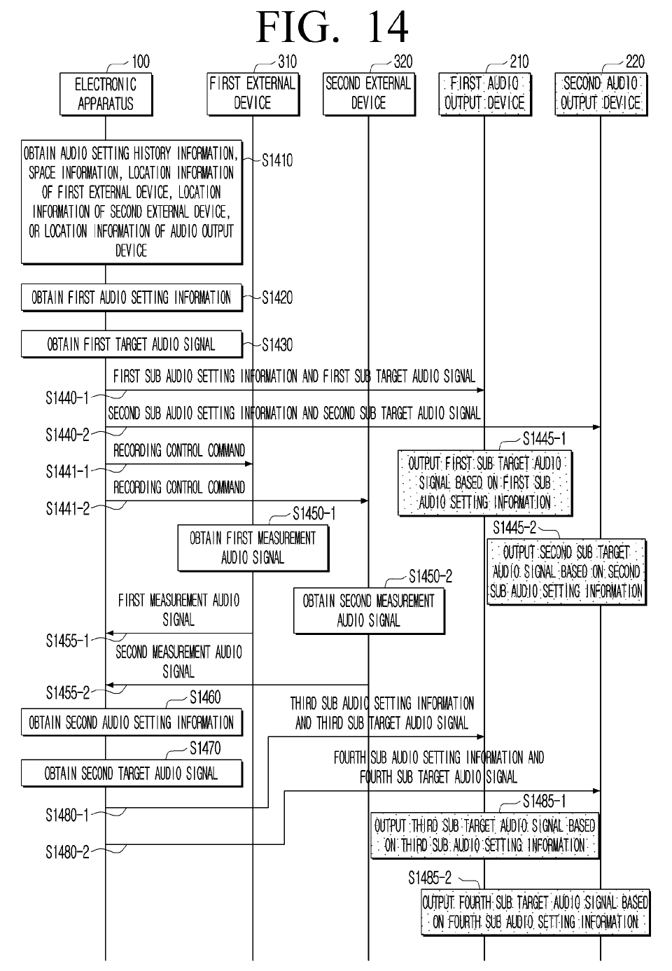

FIG. 14 illustrates an operation for providing audio setting information by using a plurality of audio output devices according to an embodiment.

Operations S1410, S1420, S1430, S1441-1, S1441-2, S1450-1, S1450-2, S1455-1, S1455-2, S1460, and S1470 of FIG. 14 may correspond to operations S1310, S1320, S1330, S1341-1, S1341-2, S1350-1, S1350-2, S1355-1, S1355-2, S1360, and S1370 of FIG. 13. Redundant descriptions thereof are thus omitted.

The audio output device 200 may include the first audio output device 210 and the second audio output device 220. The first audio output device 210 and the second audio output device 220 may each include a separate speaker. Each speaker may be a speaker for outputting a signal having a different frequency band.

The electronic apparatus 100 may obtain first audio setting information (S1420). The electronic apparatus 100 may obtain the first sub audio setting information corresponding to the first audio output device 210. The electronic apparatus 100 may obtain the first sub audio setting information based on the location information of the first audio output device 210. The electronic apparatus 100 may obtain second sub audio setting information corresponding to the second audio output device 220. The electronic apparatus 100 may obtain the second sub audio setting information based on the location information of the second audio output device 220. The first audio setting information may include the first sub audio setting information and the second sub audio setting information.

The electronic apparatus 100 may obtain the first target audio signal (S1430). The electronic apparatus 100 may obtain a first sub target audio signal corresponding to the first audio output device 210. The electronic apparatus 100 may obtain the first sub target audio signal based on the location information of the first audio output device 210. The electronic apparatus 100 may obtain a second sub target audio signal corresponding to the second audio output device 220. The electronic apparatus 100 may obtain the second sub target audio signal based on the location information of the second audio output device 220. The first target audio signal may include the first sub target audio signal and the second sub target audio signal.

The electronic apparatus 100 may transmit the first sub audio setting information and the first sub target audio signal to the first audio output device 210 (S1440-1).

The first audio output device 210 may receive the first sub audio setting information and the first sub target audio signal from the electronic apparatus 100. The first audio output device 210 may output the first sub target audio signal based on the first sub audio setting information (S1445-1).

The electronic apparatus 100 may transmit the second sub audio setting information and the second sub target audio signal to the second audio output device 220 (S1440-2).

The second audio output device 220 may receive the second sub audio setting information and the second sub target audio signal from the electronic apparatus 100. The second audio output device 220 may output the second sub target audio signal based on the second sub audio setting information (S1445-2).

While the first sub target audio signal is output from the first audio output device 210 and the second sub target audio signal is output from the second audio output device 220, the first external device 310 may obtain the first measurement audio signal (S1450-1). The first measurement audio signal may include the first sub target audio signal and the second sub target audio signal.

While the first sub target audio signal is output from the first audio output device 210 and the second sub target audio signal is output from the second audio output device 220, the second external device 320 may obtain the second measurement audio signal (S1450-2). The second measurement audio signal may include the first sub target audio signal and the second sub target audio signal.

The electronic apparatus 100 may obtain the second audio setting information (S1460).

The electronic apparatus 100 may obtain the second audio setting information by analyzing the first measurement audio signal and the second measurement audio signal. The electronic apparatus 100 may obtain the analysis result based on the first measurement audio signal and the second measurement audio signal.

The electronic apparatus 100 may obtain third sub audio setting information corresponding to the first audio output device 210. The electronic apparatus 100 may obtain the third sub audio setting information based on the analysis result and the location information of the first audio output device 210.

The electronic apparatus 100 may obtain fourth sub audio setting information corresponding to the second audio output device 220. The electronic apparatus 100 may obtain the fourth sub audio setting information based on the analysis result and the location information of the second audio output device 220. The second audio setting information may include the third sub audio setting information and the fourth sub audio setting information.

The electronic apparatus 100 may obtain the second target audio signal (S1470). The electronic apparatus 100 may obtain a third sub target audio signal corresponding to the first audio output device 210. The electronic apparatus 100 may obtain the third sub target audio signal based on the location information of the first audio output device 210. The electronic apparatus 100 may obtain a fourth sub target audio signal corresponding to the second audio output device 220. The electronic apparatus 100 may obtain the fourth sub target audio signal based on the location information of the second audio output device 220. The second target audio signal may include the third sub target audio signal and the fourth sub target audio signal.

The electronic apparatus 100 may transmit the third sub audio setting information and the third sub target audio signal to the first audio output device 210 (S1480-1).

The first audio output device 210 may receive the third sub audio setting information and the third sub target audio signal from the electronic apparatus 100. The first audio output device 210 may output the third sub target audio signal based on the third sub audio setting information (S1485-1).

The electronic apparatus 100 may transmit the fourth sub audio setting information and the fourth sub target audio signal to the second audio output device 220 (S1480-2).

The second audio output device 220 may receive the fourth sub audio setting information and the fourth sub target audio signal from the electronic apparatus 100. The second audio output device 220 may output the fourth sub target audio signal based on the fourth sub audio setting information (S1485-2).

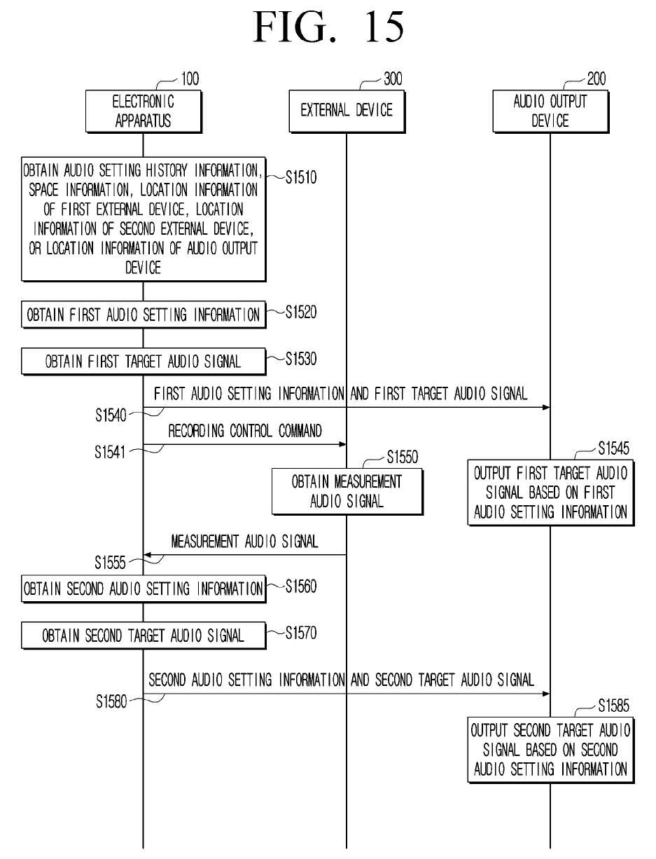

FIG. 15 illustrates an operation for providing audio setting information by using an external device and an audio output device according to an embodiment.

Operations S1510, S1520, S1530, S1540, S1545, S1560, S1570, S1580, and S1585 of FIG. 15 may correspond to operations S1310, S1320, S1330, S1340, S1345, S1360, S1370, S1380, and S1385 of FIG. 13. Redundant descriptions thereof are thus omitted.

Unlike FIG. 13, FIG. 15 illustrates that the external device 300 is a single device. For example, the external device 300 may include a single device. In another example, the external device 300 may include a plurality of devices.

When the first target audio signal is obtained, the electronic apparatus 100 may transmit the recording control command to the external device 300 (S1541). When the recording control command is received, the external device 300 may record the audio signal.

When the audio output device 200 outputs the first target audio signal, the external device 300 may obtain the measurement audio signal (S1550). The external device 300 may transmit the measurement audio signal to the electronic apparatus 100 (S1555).

The electronic apparatus 100 may receive the measurement audio signal from the external device 300. The electronic apparatus 100 may obtain an analysis result by analyzing the received measurement audio signal. The electronic apparatus 100 may obtain the second audio setting information based on the analysis result (S1560). The electronic apparatus 100 may then perform operations S1570, S1580, and S1585.

FIG. 16 illustrates an operation for providing audio setting information by using a terminal device according to an embodiment.

Operations S1610, S1620, S1630, S1640, S1641-1, S1641-2, S1645, S1650-1, S1650-2, S1655-1, S1655-2, S1660, S1670, S1680, and S1685 of FIG. 16 may correspond to operations S1310, S1320, S1330, S1340, S1341-1, S1341-2, S1345, S1350-1, S1350-2, S1355-1, S1355-2, S1360, S1370, S1380, and S1385 of FIG. 13. Redundant descriptions thereof are thus omitted.

The electronic apparatus 100 may be connected to the terminal device 330. The terminal device 330 may be connected to the electronic apparatus 100 based on a predetermined communication scheme. For example, the electronic apparatus 100 may be connected to the terminal device 330 based on the Bluetooth communication method, the UWB communication method, or the Wi-Fi communication method.

When the first target audio signal is output through the audio output device 200, the terminal device 330 may obtain the third measurement audio signal (S1650-3). The terminal device 330 may include a microphone, and may obtain the third measurement audio signal by recording the first target audio signal through the microphone. The terminal device 330 may transmit the third measurement audio signal to the electronic apparatus 100 (S1655-3).

The electronic apparatus 100 may receive the third measurement audio signal from the terminal device 330. The electronic apparatus 100 may obtain the second audio setting information based on at least one of the first measurement audio signal received from the first external device 310, the second measurement audio signal received from the second external device 320, or the third measurement audio signal received from the terminal device 330 (S1660).

The electronic apparatus 100 may obtain the analysis result based on at least one of the first measurement audio signal, the second measurement audio signal, or the third measurement audio signal. The electronic apparatus 100 may change (or update) the first audio setting information to the second audio setting information based on the analysis result. The electronic apparatus 100 may obtain the second target audio signal based on at least one of the analysis result or the second audio setting information (S1670).

The electronic apparatus 100 may then perform operations S1680 and S1685.

According to various embodiments, the electronic apparatus 100 may be connected to the first external device 310, the second external device 320, and the terminal device 330. Each of the first external device 310, the second external device 320, and the terminal device 330 may include a unique microphone.

The electronic apparatus 100 may receive the first measurement audio signal from the first external device 310.

The electronic apparatus 100 may receive the second measurement audio signal from the second external device 320.

The electronic apparatus 100 may receive the third measurement audio signal from the terminal device 330.

The electronic apparatus 100 may adjust the EQ level of the audio output device 200 or adjust sound pressure intensity for each frequency based on the third measurement audio signal.

The electronic apparatus 100 may obtain the setting information related to stereophonic sound through recognition of sound direction of the audio output device 200 based on the first measurement audio signal and the second measurement audio signal.

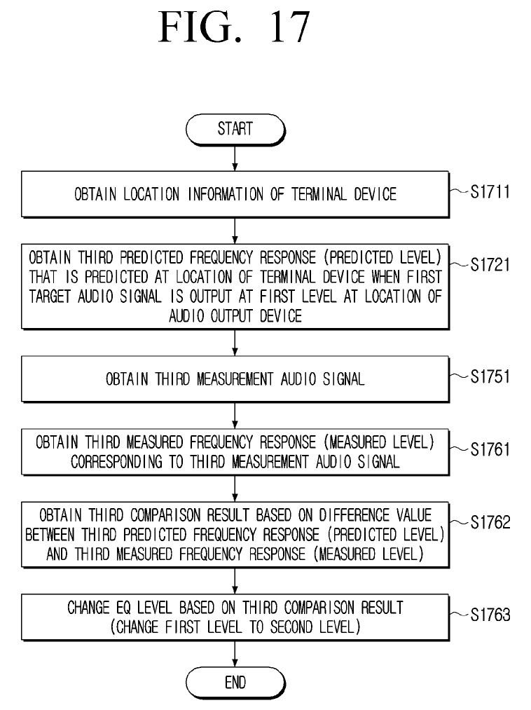

FIG. 17 illustrates an operation for obtaining first audio setting information according to an embodiment.

Referring to FIG. 17, the electronic apparatus 100 may obtain location information of the terminal device 330 (S1711). The electronic apparatus 100 may obtain the context information including the location information of the terminal device 330. The electronic apparatus 100 may obtain the first audio setting information and the first target audio signal based on the context information.

After the first audio setting information and the first target audio signal are obtained, the electronic apparatus 100 may obtain a third predicted frequency response that is predicted at a location of the terminal device 330 when the first target audio signal is output at the first level at the location of the audio output device 200 (S1721).

After the first target audio signal is output from the audio output device 200, the electronic apparatus 100 may receive the third measurement audio signal from the terminal device 330 (S1751).

The electronic apparatus 100 may obtain a third measured frequency response (measured level) corresponding to the third measurement audio signal (S1761). The electronic apparatus 100 may obtain a third comparison result based on a difference value between the third predicted frequency response (predicted level) and the third measured frequency response (measured level) (S1762).

The electronic apparatus 100 may change the EQ level based on the third comparison result (S1763). The electronic apparatus 100 may change the first level to the second level.

The electronic apparatus 100 may change the EQ level by additionally using the first comparison result and the second comparison result mentioned in an embodiment illustrated in FIG. 11. The electronic apparatus 100 may change the EQ level based on at least one of the first comparison result, the second comparison result, or the third comparison result. The content related to FIG. 11 may be applied to an embodiment illustrated in FIG. 17 in the same manner.

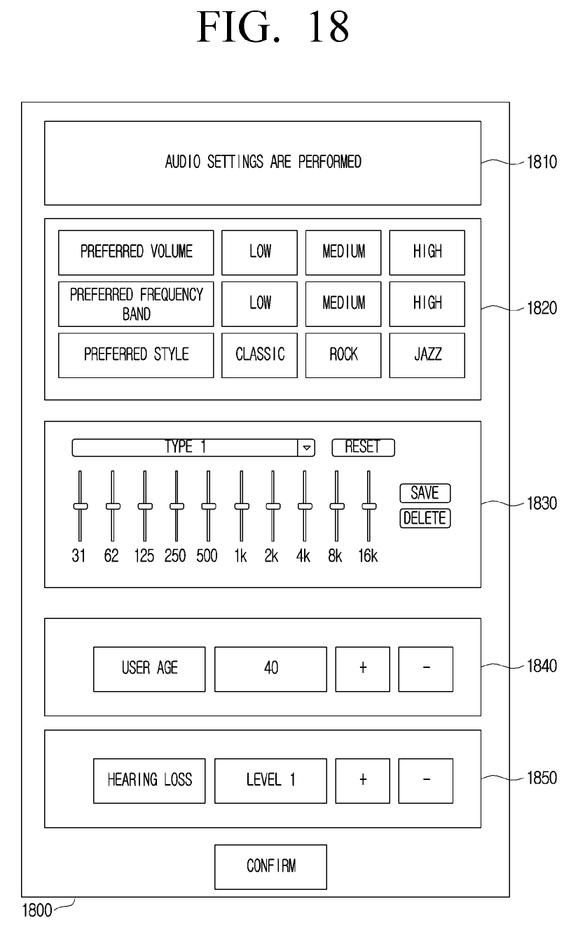

FIG. 18 illustrates a screen related to audio setting information according to an embodiment.

Referring to FIG. 18, the electronic apparatus 100 may provide a screen 1800 related to audio setting. When the first audio setting information or the second audio setting information is obtained, the electronic apparatus 100 may provide the screen 1800 related to audio setting.

The screen 1800 may include the history information related to audio settings. The screen 1800 may include at least one of a UI 1810 indicating that the screen is related to audio setting, a UI 1820 indicating user personal preference settings, a UI 1830 indicating predetermined EQ settings, a UI 1840 indicating a user age, or a UI 1850 indicating user hearing ability information.

The electronic apparatus 100 may receive a user input related to audio setting through the screen 1800. The electronic apparatus 100 may change (or update) the audio setting based on the user input.

For example, when the user input is received through the UI 1840, the electronic apparatus 100 may change the user age based on the user input.

For example, when a user input is received through the UI 1850, the electronic apparatus 100 may change the user hearing ability information based on the user input.

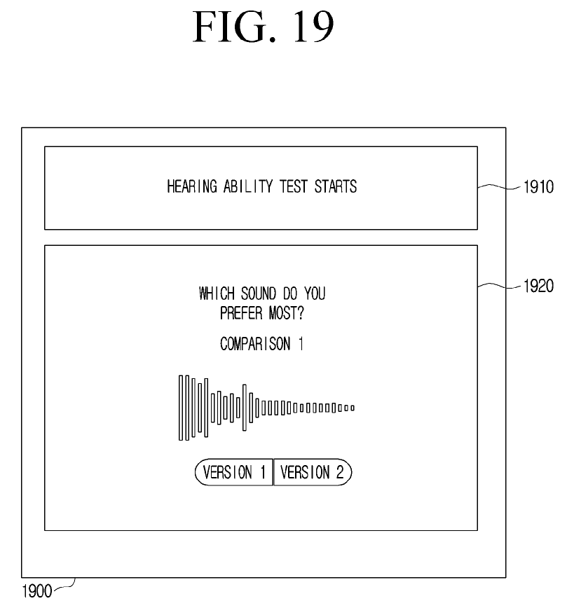

FIG. 19 illustrates a screen for obtaining context information according to an embodiment.

Referring to FIG. 19, the electronic apparatus 100 may provide a screen 1900 related to a hearing ability test. The electronic apparatus 100 may obtain the context information. The context information may include the user hearing ability information. The electronic apparatus 100 may obtain the user hearing ability information based on the hearing ability test.

The electronic apparatus 100 may start the hearing ability test based on a predetermined event. When an event in which a predetermined user command is received or an event in which a predetermined application is executed occurs, the electronic apparatus 100 may perform a function corresponding to the hearing ability test.

The electronic apparatus 100 may provide the screen 1900 related to the hearing ability test. The screen 1900 may include at least one of a UI 1910 indicating the hearing ability test or a guide UI 1920 related to the hearing ability test.

The UI 1920 may guide selection between a predetermined first candidate sound or a predetermined second candidate sound.

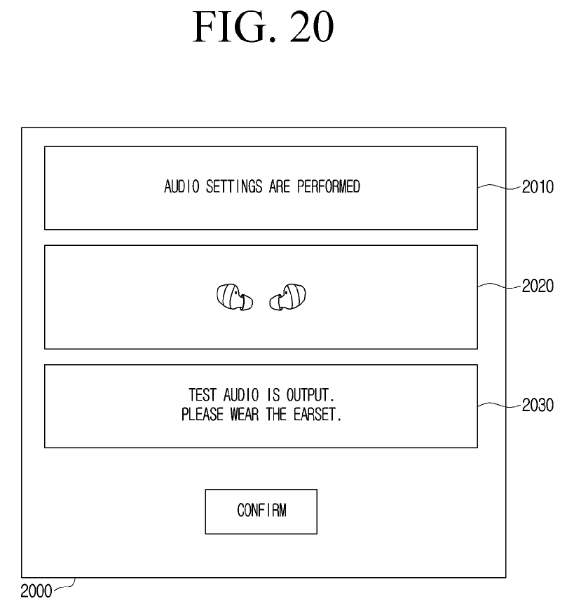

FIG. 20 illustrates a screen for performing audio setting according to an embodiment.

Referring to FIG. 20, the electronic apparatus 100 may provide a screen 2000 related to audio setting.

The screen 2000 may include at least one of a UI 2010 indicating provision of the screen related to audio setting, a UI 2020 including image information indicating the external device, or a UI 2030 including a guide operation related to the audio setting.

The UI 2030 may include at least one of information indicating outputting of test audio or information indicating a guide operation for wearing a device included in the UI 2020. The device included in the UI 2020 may include image information corresponding to at least one of the first external device 310 or the second external device 320.

The user may easily recognize, through the screen 2000, that the guide operation included in the UI 2030 is to be performed in relation to a device corresponding to the UI 2020.

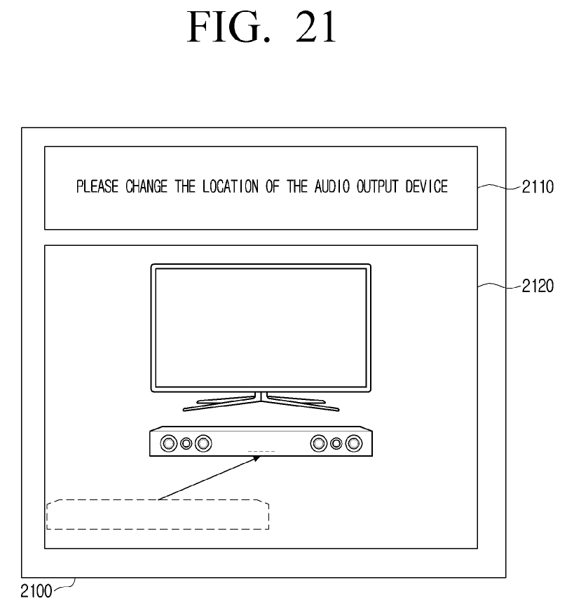

FIG. 21 illustrates a screen indicating a location of an audio output device according to an embodiment.

Referring to FIG. 21, the electronic apparatus 100 may provide a screen 2100 for changing a location of the audio output device 200. The electronic apparatus 100 may obtain the location information of the audio output device 200. The electronic apparatus 100 may change the location of the audio output device 200 to provide an optimal audio environment. In a process of obtaining the first audio setting information, the electronic apparatus 100 may identify that a location change of the audio output device 200 is required. The electronic apparatus 100 may provide a guide screen 2100 for changing the location of the audio output device 200.

The screen 2100 may include at least one of a UI 2110 indicating that the location change of the audio output device 200 is required or a UI 2120 including image information for guiding the changed location. The UI 2120 may include a previous location and a changed location of the audio output device 200.

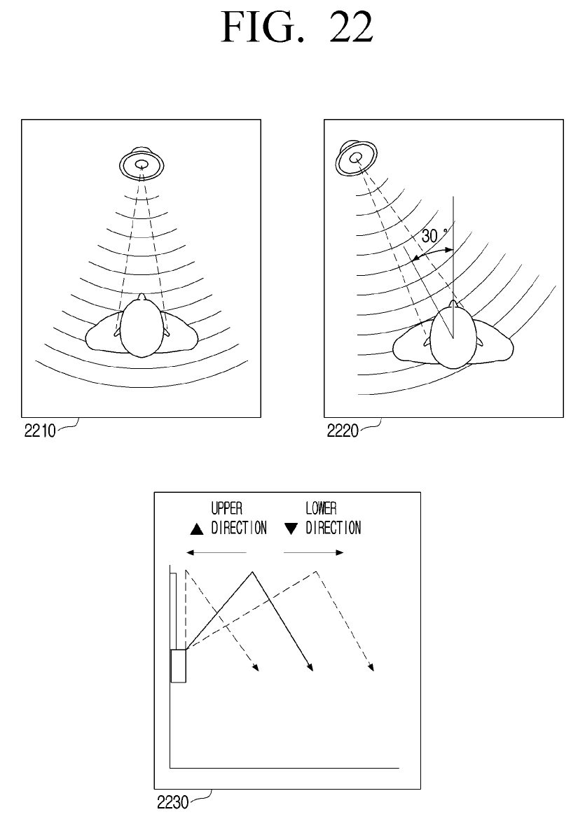

FIG. 22 illustrates an operation for obtaining second audio setting information according to an embodiment.

Embodiment 2210 of FIG. 22 may represent a situation in which the audio output device 200 is located in front of the user. In Embodiment 2210, the user wears the first external device 310 and the second external device 320. The audio output device 200 may be located in front of the user, and accordingly, the time difference information between the first measurement audio signal obtained from the first external device 310 and the second measurement audio signal obtained from the second external device 320 may be zero.

Embodiment 2220 of FIG. 22 may represent a situation in which the audio output device 200 is located at a side of the user. In Embodiment 2220, the user wears the first external device 310 and the second external device 320. The audio output device 200 may be located at the side of the user, and accordingly, the time difference information between the first measurement audio signal obtained from the first external device 310 and the second measurement audio signal obtained from the second external device 320 may be non-zero.

The electronic apparatus 100 may obtain time difference information by analyzing the first measurement audio signal and the second measurement audio signal. The electronic apparatus 100 may obtain (or verify) the location of the audio output device 200 based on the time difference information.

In an embodiment, the first external device 310 is worn on the left side of the user based on the direction in which the user faces the audio output device 200. In an embodiment, the second external device 320 is worn on the right side of the user based on the direction in which the user faces the audio output device 200.

For example, when the time difference information between the first measurement audio signal and the second measurement audio signal is zero, the electronic apparatus 100 may identify that the audio output device 200 is located in front of the user.

For example, when a reception time point of the first target audio signal is earlier than a reception time point of the second target audio signal, the electronic apparatus 100 may identify that the audio output device 200 is located on the left side of the user.

For example, when the reception time point of the first target audio signal is later than the reception time point of the second target audio signal, the electronic apparatus 100 may identify that the audio output device 200 is located on the right side of the user.

The electronic apparatus 100 may identify that a time difference of pulses of an audio signal occurs based on a speaker direction. The electronic apparatus 100 may recognize stereophonic sound in upper, lower, left, and right directions.

Embodiment 2230 of FIG. 22 represents a situation in which an audio signal is reflected (or diffracted) by one surface of a space. The audio signal output from the audio output device 200 may be reflected by a specific wall surface (e.g., a wall or a ceiling). An audio signal that is not reflected may be described as a direct wave, and a reflected audio signal may be described as a reflected wave. The electronic apparatus 100 may obtain (or verify) the space information by comparing the direct wave with the reflected wave in the measurement audio signal. The space information may include at least one of the space shape or the space size. The electronic apparatus 100 may check (or verify) whether output of the audio output device 200 disposed in a listening space is normally performed at the user location.

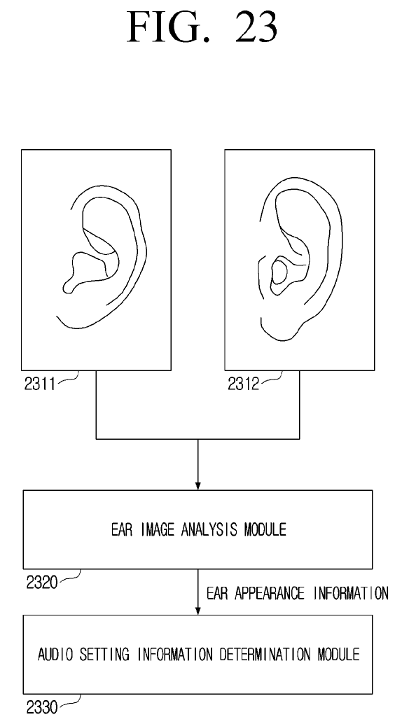

FIG. 23 illustrates an operation for obtaining audio setting information according to an embodiment.

Referring to FIG. 23, the electronic apparatus 100 may obtain images 2311 and 2312 including a user ear. The electronic apparatus 100 may obtain ear appearance information by inputting the images 2311 and 2312 to an ear image analysis module 2320.

The ear image analysis module 2320 may obtain ear appearance information including feature information related to the user ear. The ear appearance information may include ear shape information. The ear shape information may include information indicating the structure or shape of ears.

The electronic apparatus 100 may obtain the audio setting information by inputting the ear appearance information to an audio setting information determination module 2330. The audio setting information determination module 2330 may obtain the audio setting information by additionally use the ear appearance information.

The electronic apparatus 100 may obtain the setting information related to stereophonic sound based on the ear appearance information. Ear appearance information differs for each user, and accordingly, when user-specific ear appearance information is obtained, the electronic apparatus 100 may provide an audio environment personalized for the user.

The electronic apparatus 100 may classify the ear appearance information into a plurality of predetermined types. The predetermined types may be classified based on an ear shape or, ear canal size, or the like.

The electronic apparatus 100 may store a mapping table mapping user ears to audio settings, including the first audio setting information corresponding to a first type and the second audio setting information corresponding to a second type.

The electronic apparatus 100 may identify a user ear type based on the ear appearance information. The electronic apparatus 100 may obtain audio setting information corresponding to the identified user ear type based on the mapping table. When the user ear is identified as corresponding to the first type based on an image including the user ear, the electronic apparatus 100 may obtain the first audio setting information corresponding to the first type based on the mapping table. The electronic apparatus 100 may transmit the first audio setting information to the audio output device 200.

FIG. 24 illustrates a user database according to an embodiment.

Referring to FIG. 24, the electronic apparatus 100 may store a database related to at least one user. The database may include a table 2400 including history information related to at least one user.

The table 2400 may include at least one of identification information, a user name, a preferred volume, a preferred frequency, or a level related to EQ settings. The table 2400 may include a user setting history related to an audio environment.

The electronic apparatus 100 may store a database including the user setting history related to the audio environment.

When it is determined that the user accesses thereto, the electronic apparatus 100 may obtain history information corresponding to the user. The electronic apparatus 100 may obtain the audio setting information corresponding to the user based on the obtained history information.

The electronic apparatus 100 may scan (or search for) nearby devices present around the electronic apparatus 100. The electronic apparatus 100 may obtain identification information of scanned nearby devices. The electronic apparatus 100 may determine whether the identification information corresponds to pre-registered information. The identification information may include at least one of device identification information or user account information.

When the identification information corresponds to the pre-registered information, the electronic apparatus 100 may obtain the audio setting information (or history information) stored in the database based on the identification information.

According to various embodiments, when two scanned nearby devices are present and both devices are pre-registered, the electronic apparatus 100 may obtain the audio setting information based on a pre-stored priority. For example, a first user is an administrator and a second user is a general user. When a device of the first user and a device of the second user are both scanned, the electronic apparatus 100 may obtain and apply audio setting information corresponding to the first user.

According to various embodiments, when two scanned nearby devices are present and both devices are pre-registered, the electronic apparatus 100 may obtain final audio setting information based on an average value (or a median value) of the audio setting information of each of the two devices. For example, the electronic apparatus 100 may obtain and apply the final audio setting information based on an average value (or a median value) of the audio setting information corresponding to the first user and audio setting information corresponding to the second user.

FIG. 25 illustrates an operation for obtaining first audio setting information by using a pre-registered terminal device according to an embodiment.

Referring to FIG. 25, the electronic apparatus 100 may scan nearby devices (S2501). The electronic apparatus 100 may identify a first terminal device based on a scanning result (S2502). The electronic apparatus 100 may identify whether the first terminal device is pre-registered (S2503). The electronic apparatus 100 may identify whether the first terminal device or a user account corresponding to the first terminal device is pre-registered, based on a pre-stored database.

When the first terminal device is pre-registered (S2503-Y), the electronic apparatus 100 may obtain the first audio setting information corresponding to the pre-registered first terminal device (S2504).

When the first terminal device is not pre-registered (S2503-N), the electronic apparatus 100 may obtain the context information for audio settings (S2510). The electronic apparatus 100 may obtain the first audio setting information based on the context information (S2520).

The steps S2510 and S2520 may correspond to the steps S910 and S920 of FIG. 9. Redundant descriptions thereof are thus omitted. When the first audio setting information is obtained in the steps S2504 and S2520, the electronic apparatus 100 may perform the steps S930 to S980 of FIG. 9.

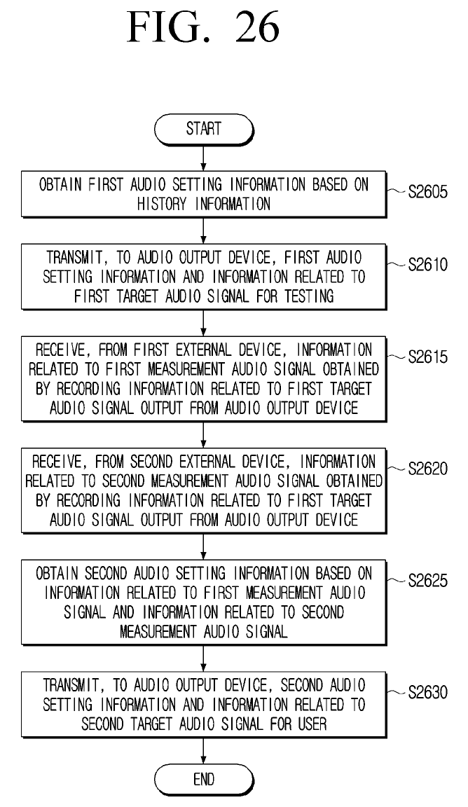

FIG. 26 illustrates a control method for an electronic apparatus 100 according to an embodiment.

Referring to FIG. 26, provided is a control method for an electronic apparatus that stores the history information related to audio settings and communicates with the audio output device, the first external device including a microphone, and the second external device including a microphone, the method including: obtaining the first audio setting information based on the history information (S2605); transmitting, to the audio output device, the first audio setting information and the information related to the first target audio signal for testing (S2610); receiving, from the first external device, the information related to the first measurement audio signal obtained by recording the information related to the first target audio signal output from the audio output device (S2615); receiving, from the second external device, the information related to the second measurement audio signal obtained by recording the information related to the first target audio signal output from the audio output device (S2620); obtaining the second audio setting information based on the information related to the first measurement audio signal and the information related to the second measurement audio signal (S2625); and transmitting, to the audio output device, the second audio setting information and the information related to the second target audio signal for the user (S2630).

The history information may include at least one of the preferred volume, the preferred frequency band, the preferred style, the preferred EQ (Equalizer) setting information, or the hearing ability information, and the hearing ability information may include at least one of the user age, the user gender, or the audible frequency range.

The obtaining of the first audio setting information (S2605) may include: obtaining the first location information of the first external device and the second location information of the second external device based on the location of the electronic apparatus; and obtaining the first audio setting information based on the history information, the first location information, and the second location information.

The obtaining of the first audio setting information (S2605) may include: obtaining the third location information of the audio output device; and obtaining the first audio setting information based on the history information and the third location information.

The obtaining of the second audio setting information (S2625) may include: obtaining the first predicted frequency response (predicted level) that is predicted at the location of the first external device when the first target audio signal is output from the audio output device; obtaining the first measured frequency response (measured level) corresponding to the first measurement audio signal; obtaining the difference value between the first predicted frequency response (predicted level) and the first measured frequency response (measured level); and obtaining the second audio setting information by applying the difference value to the first audio setting information.

The obtaining of the first audio setting information (S2605) may include: obtaining the space information including the characteristics of the space in which the electronic apparatus is disposed; and obtaining the first audio setting information based on the history information and the space information, and the space information may include at least one of the space shape or the space size.

The control method may further include: obtaining the user identification information corresponding to the first external device or the second external device; and obtaining the history information corresponding to the identification information from among the plurality of user-specific history information stored in the electronic apparatus.

The audio output device may include the first audio output device and the second audio output device, and the second audio setting information may include the first stereophonic sound information corresponding to the first audio output device and the second stereophonic sound information corresponding to the second audio output device.

The information related to the first measurement audio signal may include an audio signal obtained while the noise canceling function is performed in the first external device, and the information related to the second measurement audio signal may include an audio signal obtained while the noise canceling function is performed in the second external device.

The first external device may correspond to the left device of an earset, and the second external device may correspond to the right device of the earset.

The methods according to the various embodiments of the present disclosure described above may be implemented in the form of an application capable of being installed on a conventional electronic apparatus.

The methods according to the various embodiments of the present disclosure described above may be implemented only by software upgrade or hardware upgrade of the conventional electronic apparatus.

The various embodiments of the present disclosure described above may be performed through an embedded server included in the electronic apparatus, or through an external server of at least one of the electronic apparatus or a display device

According to an embodiment of the present disclosure, the various embodiments described above may be implemented by software including an instruction stored on a machine-readable storage medium, the instructions being readable by a machine (e.g., a computer). The machine may be a device that invokes the stored instruction from a storage medium, may be operated based on the invoked instruction, and may include the electronic apparatus according to the disclosed embodiments. When the instruction is executed by the processor, the processor may directly perform, or perform functions corresponding to the instructions by using other components under control of the processor. The instruction may include codes generated or executed by a compiler or an interpreter. The machine-readable storage medium may be provided in the form of a non-transitory storage medium. Here, the term “non-transitory” merely indicates that the storage medium is tangible without including a signal, and does not distinguish whether data are semi-permanently or temporarily stored in the storage medium.

According to an embodiment of the present disclosure, the methods according to the various embodiments described above may be provided as a computer program product. The computer program product may be traded as a product between a seller and a buyer. The computer program product may be distributed in the form of a machine-readable storage medium (e.g., a compact disc read only memory (CD-ROM)) or online through an application store (e.g., Play Store™). In the case of online distribution, at least a part of the computer program product may be temporarily stored or generated in a storage medium such as a memory of a manufacturer server, an application store server, or a relay server.

Each of the components (e.g., modules or programs) according to the various embodiments described above may include a single entity or a plurality of entities, and some of the corresponding sub-components described above may be omitted or other sub-components may be further included in the various embodiments. Alternatively or additionally, some of the components (e.g., the modules or the programs) may be integrated into one entity, and may perform functions performed by the respective corresponding components before integration in the same or similar manner. Operations performed by the modules, the programs or other components according to the various embodiments may be executed in a sequential manner, a parallel manner, an iterative manner or a heuristic manner, at least some of the operations may be performed in a different order or be omitted, or other operations may be added.

Although the preferred embodiments of the present disclosure are illustrated and described as above, the present disclosure is not limited to the above-described specific embodiments, and may be variously modified by those skilled in the art to which the present disclosure pertains without departing from the scope of the present disclosure of the accompanying claims. These modifications fall within the spirit of the present disclosure.

What is claimed is:

1. An electronic apparatus comprising:
a memory storing history information related to audio settings;
a communication interface configured to communicate with an audio output device, a first external device including a first microphone, and a second external device including a second microphone; and
at least one processor configured to:
obtain first audio setting information based on the history information;
transmit, to the audio output device, the first audio setting information and information related to a first target audio signal for testing;
receive, from the first external device through the communication interface, information related to a first measurement audio signal obtained by recording the information related to the first target audio signal output from the audio output device;
receive, from the second external device through the communication interface, information related to a second measurement audio signal obtained by recording the information related to the first target audio signal output from the audio output device;
obtain second audio setting information based on the information related to the first measurement audio signal and the information related to the second measurement audio signal; and
transmit, to the audio output device through the communication interface, the second audio setting information and information related to a second target audio signal for a user.

2. The electronic apparatus of claim 1, wherein the history information includes at least one of a preferred volume, a preferred frequency band, a preferred style, preferred equalizer (EQ) setting information, or hearing ability information, and
wherein the hearing ability information includes at least one of a user age, a user gender, or an audible frequency range.

3. The electronic apparatus of claim 1, wherein the at least one processor is further configured to:
obtain first location information of the first external device and obtain second location information of the second external device based on a location of the electronic apparatus; and
obtain the first audio setting information based on the history information, the first location information, and the second location information.

4. The electronic apparatus of claim 1, wherein the at least one processor is further configured to:
obtain third location information of the audio output device; and
obtain the first audio setting information based on the history information and the third location information.

5. The electronic apparatus of claim 1, wherein the at least one processor is further configured to:
obtain a first predicted frequency response predicted at a location of the first external device in a case that the first target audio signal is output from the audio output device;
obtain a first measured frequency response corresponding to the first measurement audio signal;
obtain a difference value between the first predicted frequency response and the first measured frequency response; and
obtain the second audio setting information by applying the difference value to the first audio setting information.

6. The electronic apparatus of claim 1, wherein the at least one processor is further configured to:
obtain space information including characteristics of a space in which the electronic apparatus is disposed; and
obtain the first audio setting information based on the history information and the space information, and
wherein the space information includes at least one of a space shape or a space size.

7. The electronic apparatus of claim 1, wherein the at least one processor is further configured to:
obtain user identification information corresponding to the first external device or the second external device; and
obtain, from the memory, the history information corresponding to the user identification information.

8. The electronic apparatus of claim 1, wherein the audio output device includes a first audio output device and a second audio output device, and
wherein the second audio setting information includes first stereophonic sound information corresponding to the first audio output device and second stereophonic sound information corresponding to the second audio output device.

9. The electronic apparatus of claim 1, wherein the information related to the first measurement audio signal includes a first audio signal obtained while a noise canceling function is performed in the first external device, and
wherein the information related to the second measurement audio signal includes a second audio signal obtained while the noise canceling function is performed in the second external device.

10. The electronic apparatus of claim 1, wherein the first external device corresponds to a left device of an earset, and
wherein the second external device corresponds to a right device of the earset.

11. A method performed by an electronic apparatus that stores history information related to audio settings and that is configured to communicate with an audio output device, a first external device including a first microphone, and a second external device including a second microphone, the method comprising:
obtaining first audio setting information based on the history information;
transmitting, to the audio output device, the first audio setting information and information related to a first target audio signal for testing;
receiving, from the first external device, information related to a first measurement audio signal obtained by recording the information related to the first target audio signal output from the audio output device;
receiving, from the second external device, information related to a second measurement audio signal obtained by recording the information related to the first target audio signal output from the audio output device;
obtaining second audio setting information based on the information related to the first measurement audio signal and the information related to the second measurement audio signal; and
transmitting, to the audio output device, the second audio setting information and information related to a second target audio signal for a user.

12. The method of claim 11, wherein the history information includes at least one of a preferred volume, a preferred frequency band, a preferred style, preferred equalizer (EQ) setting information, or hearing ability information, and
wherein the hearing ability information includes at least one of a user age, a user gender, or an audible frequency range.

13. The method of claim 11, wherein the obtaining of the first audio setting information includes:
obtaining first location information of the first external device and second location information of the second external device based on a location of the electronic apparatus; and
obtaining the first audio setting information based on the history information, the first location information, and the second location information.

14. The method of claim 11, wherein the obtaining of the first audio setting information includes:
obtaining third location information of the audio output device; and
obtaining the first audio setting information based on the history information and the third location information.

15. The method of claim 11, wherein the obtaining of the second audio setting information includes:
obtaining a first predicted frequency response predicted at a location of the first external device in a case that the first target audio signal is output from the audio output device;
obtaining a first measured frequency response corresponding to the first measurement audio signal;
obtaining a difference value between the first predicted frequency response and the first measured frequency response; and
obtaining the second audio setting information by applying the difference value to the first audio setting information.
